(19) United States
(12) Patent Application Publication
(10) Pub. No.: US 2023/0256442 A1
(43) Pub. Date: Aug. 17, 2023

(54) SYSTEMS AND METHODS FOR TRAPPING AND TRANSPORTING SMALL PARTICLES WITH ACOUSTIC FORCES

(71) Applicant: DUKE UNIVERSITY, Durham, NC (US)

(72) Inventors: Steven Cummer, Durham, NC (US); Junfei Li, Durham, NC (US); Chen Shen, Durham, NC (US)

(21) Appl. No.: 18/111,176

(22) Filed: Feb. 17, 2023

Related U.S. Application Data
(60) Provisional application No. 63/311,125, filed on Feb. 17, 2022.

(51) Int. Cl. B01L 3/00

(52) U.S. Cl. CPC B01L 3/502761; B01L 2200/0652; B01L 2400/049; B01L 2400/0439; B01L 2300/168; B01L 2300/14

(57) ABSTRACT

The present disclosure describes systems and methods for versatile acoustic tweezer trapping and transport configurations. Examples can use ultrasound for contact-free, biocompatible, and precise manipulation of particles from millimeter to sub-micrometer scale along a narrow and complex path. Examples include spatially complex particle trapping and manipulation inside a boundary-free chamber using a single pair of sources and a shadow waveguide. The shadow waveguide structure can be disposed just outside a microfluidic chamber to guide and control the acoustic wave fields inside the chamber. The shadow waveguide can create a tightly confined, spatially complex acoustic field inside the chamber without an interior structure that could interfere with net flow or transport.

### CROSS-REFERENCE TO RELATED APPLICATIONS

This application claims priority to and the benefit of U.S. Provisional Application Ser. No. 63/311,125, entitled “METHOD TO TRAP AND TRANSPORT SMALL PARTICLES WITH ACOUSTIC FORCES,” and filed Feb. 17, 2022, the contents of which are incorporated by reference herein in its entirety.

### GOVERNMENT RIGHTS

This invention was made with Government support under Federal Grant no. N00014-13-1-0631 awarded by the Office of Naval Research and by Federal Grant No. 1641084 awarded by the National Science Foundation. The Government has certain rights in the invention.

### FIELD

The following disclosures relates to using acoustic forces to manipulate small particles in a fluid and, more specifically, to manipulating particles in a fluid without the use of a physical barrier in the fluid layer or channel.

### BACKGROUND

Acoustic tweezers use ultrasonic waves to trap and manipulate small, often cell-sized, particles, usually in water, for biological or chemical applications. Many existing approaches for acoustic tweezers use an array of multiple ultrasound sources disposed outside of a water-filled chamber that contains the particles to be manipulated, where the spatial shape of the sound field controls how the particles in the chamber are trapped or moved. However, an array of sources outside the chamber has limits on the shape of the sound fields that can be generated. For example, it cannot generate a single trapping path along which a particle can be moved, nor can it create a single isolated trapping point.

One solution is to place physical boundaries inside the chamber to create narrow channels that help guide the particles along preferred trajectories or to help trap particles at a single point. However, the presence of physical boundaries is not useful if particles in the chamber need to avoid contact with anything other than the water they are in. Such considers are critical for certain types of parties and particle arrangements that may be damage or destroyed during transport if they contact a physical boundary. Additionally, the inclusion of physical boundaries also increases system complexity, at least because of the challenges involved in creating small channels inside the chamber. Hence, there is an ongoing opportunity for improved systems and methods of particle manipulation with acoustic tweezers.

### SUMMARY

The Summary is provided to introduce a selection of concepts that are further described below in the Detailed Description. This Summary is not intended to identify key or essential features of the claimed subject matter, nor is it intended to be used as an aid in limiting the scope of the claimed subject matter.

Typical microfluidic channels confine fluid and particles by creating a thin channel or pipe with physical boundaries at the micron scale. Such a thin pipe results in high flow resistance, and thus the flow rate is limited. Additionally, thin channels can easily clog with particles that stick to the boundaries. Compared with traditional microfluidic devices, illustrative embodiments replace physical walls with acoustic walls, so that particles can be confined within a thin channel even in a wide-open chamber. Removing physical walls cannot only prevent particle clogging, but also allows a much faster flow rate. In some embodiments, a boundary structure approach is used for controlling wave fields and propagation inside an open chamber through thin, broadband structures that are completely exterior to the fluid layer

Some examples of the present disclosure enable particle transport along a predefined path that is not necessarily a straight line and even can have splits (e.g., having a Y-shape) with only one or two acoustic sources. Examples of the acoustic tweezer systems of the present disclosure can be used to pattern and hold cells into fixed shapes that are challenging for standard acoustofluidics approaches.

One example implementation of the acoustic tweezer systems of present disclosure is a fast particle transport along a complex predefined path, with application of cell screening. Studies have shown that cell patterning plays a key role during the cell differentiation process. Compared with randomly distributed cells, patterning with ultrasound can guide cells to grow into a more functional tissue. However, typical acoustofluidic trapping techniques are limited in the trapping shape that they can deliver. The illustrative embodiments of the present application may be used in a variety of technical fields and practices, including but not limited to biomedical and chemical arts. In some embodiments, the system may be used to pattern tissues, cells, or cell products. In other embodiments, the system is used to sort or separate cells, for example, through flow cytometry. The system may also be used to manipulate cell interactions on a chip or microchip. Further examples of uses of the illustrative embodiments include stimulation of cells or tissues through an acoustic field.

In the chemical arts, illustrative embodiments may be used to control droplets in a microfluidic chamber. This process may be done before, during, or after a chemical reaction. In other embodiments, the system may be used in a device to provide specific fluidic environments to a reaction.

Examples of the present disclosure include in acoustic tweezer device, including a microfluidic chamber and a waveguide control structure, where the external waveguide control structure is disposed outside the chamber (e.g., a fluid layer) and is configured to trap and manipulate particles without any physical boundary inside the chamber. The external waveguide control structure can extend along a trajectory that defines a narrow and arbitrarily shaped particle path. The external waveguide control structure can be configured to trap particles having positive acoustic contrasts. The external waveguide control structure can be configured to trap particles having negative acoustic contrasts. The external waveguide control structure can include at least one of a waveguide, a point array, a shaped hydrogel, a surface pattern, and/or a surface layer material. An example acoustic tweezer system can include the acoustic tweezer device according to the present disclosure and a wave generator configured to create a static or dynamic standing wave pattern along the particle path. The wave generator can include of two wave sources. The system can include one or more lenses configured to focus and couple incident waves into the external waveguide control structure. Another aspect of the present disclosure provides a method of particle trapping, including using a device or system as disclosed herein. Another example of the present disclosure is a method of particle trapping that including using a device or system according to any of the examples disclosed herein.

Examples of the present disclosure provide for acoustic tweezer devices that include a microfluidic chamber and an external waveguide control structure, where the external waveguide control structure is disposed outside the microfluidic chamber and is configured to trap and manipulate particles without any physical boundary inside the chamber. The external waveguide control structure can extend along a trajectory that defines a narrow and arbitrarily shaped particle path. In some embodiments, the external waveguide control structure is configured to trap particles having positive acoustic contrasts, or the external waveguide control structure is configured to trap particles having negative acoustic contrasts. The external waveguide control structure can include at least one of a waveguide, a point array, a shaped hydrogel, a surface pattern, and/or a surface layer material.

Another example of the present disclosure provides for an acoustic tweezer system that includes a microfluidic chamber, an external waveguide control structure, and a wave generator configured to create a static or dynamic standing wave pattern along the particle path. The wave generator can include at least two wave sources. In some example, the system includes one or more lenses configured to focus and couple incident waves into the external waveguide control structure.

One example of the present disclosure is an acoustic tweezer device that includes a fluid layer and a waveguide control structure disposed adjacent to the fluid layer. The waveguide control structure can be made from a solid material that defines at least one cavity having a different acoustic impedance than both the solid material and the fluid layer, which can be, for example, a positive acoustic contrast with both the solid material and the fluid layer. The cavity can be a region within the solid material with different acoustic properties, containing, for example, a vacuum, a gas, a fluid, or another solid material. The at least one cavity defines a waveguide in the solid material, with the waveguide extending along the fluid layer and defining a path of an acoustic microfluidic conduit in an adjacent portion of the fluid layer. The waveguide control structure is configured to direct acoustic energy along the waveguide and through the acoustic microfluidic conduit to trap and manipulate particles in the acoustic microfluidic conduit without any physical boundary in the fluid layer. The term acoustic microfluidic conduit or acoustic conduit is used herein to describe a non-physically bound (at least in 2 dimensions, e.g., a quasi-2D open chamber) region within the fluid layer that defines a particle path using only acoustic energy. The at least one cavity can include separate first and second lateral portions extending along the fluid layer and defining the waveguide in the solid material therebetween. The path of the waveguide can define a narrow and arbitrarily shaped path of the acoustic microfluidic conduit within the fluid layer. The waveguide can include a portion of the solid material having a greater thickness than adjacent portions of the solid material disposed between the first and second lateral portions of the cavity and the fluid layer. The waveguide control structure can include at least one of a waveguide, a point array, a shaped hydrogel, a surface pattern, and/or a surface layer material.

In some examples, the waveguide control structure is configured to trap at least one of particles having positive acoustic contrasts or particles having negative acoustic contrasts in the acoustic microfluidic chamber. The waveguide can include first and second waveguides extending together along the fluid layer, and where a portion of the at least one cavity is disposed between the first and second waveguides. The first and second waveguides can define separate first a second acoustic microfluidic conduits. In some examples, the first and second waveguides together define a single acoustic microfluidic conduits in a portion of the fluid layer adjacent to a region of the waveguide control structure between the first and second waveguides.

The example device can further include a substrate layer disposed adjacent to the waveguide control layer and opposite to the fluid layer. In some examples, the device includes a cover layer disposed adjacent to the fluid layer and opposite to the waveguide control layer. In some examples, the at least one cavity is filled with a gas or contains a vacuum. The fluid layer can include water and the solid material of the waveguide structure includes polydimethylsiloxane. The waveguide control structure can include a membrane layer disposed between the fluid layer and the at least one cavity. The membrane layer can at least partially enclose the at least one cavity.

In some examples, the acoustic microfluidic conduit defines a quasi-2D open chamber.

In some examples, the device includes a first acoustic lens acoustically coupled to a first end of the waveguide and a second acoustic lens acoustically coupled to a second end of the waveguide, where the first and second ends of the waveguide includes respective first and second ends of the path of the microfluidic acoustic conduit, and where the first and second acoustic lenses are each configured to direct and concentrate acoustic energy from a respective acoustic source into a respective one of the first or second ends of the waveguide. In some examples, the first acoustic lens is disposed adjacent to the first end of the waveguide, and where the second acoustic lens is disposed adjacent to the second end of the waveguide.

Yet another example of the present disclosure is an acoustic tweezer device that includes a fluid layer and a waveguide control structure disposed adjacent to the fluid layer and includes solid material, the solid material at least partially surrounding at least one region having a different acoustic impedance than both the solid material and the fluid layer. The at least one region defines a waveguide in the solid material, the waveguide extending along the fluid layer and defining a path in an adjacent portion of the fluid layer, the waveguide control structure is configured to direct acoustic energy along the waveguide and also through the fluid layer, in the direction of the waveguide, in a localized region of the fluid layer adjacent to the waveguide, and the acoustic energy in the fluid layer adjacent to the waveguide traps and manipulates particles in the localized region along the path of the waveguide control structure.

Still another example is a method of trapping particles with an acoustic tweezer device that includes directing acoustic waves into a first end of a waveguide of an acoustic tweezer device, the waveguide defined by at least one cavity in a waveguide control structure that is adjacent to a fluid layer of the device, the at least one cavity having positive acoustic contrast with both the waveguide control structure and the fluid layer, directing acoustic waves into a second end of the waveguide, and adjusting at least one of the acoustic waves into the first or second ends of the waveguide to trap and manipulate particles in an acoustic microfluidic conduit in the fluid layer adjacent to the waveguide. Where the waveguide extends along a path along an interface between the fluid layer and the waveguide control structure and the acoustic waves directed into the first and second ends of the waveguide is propagated along the path to define the acoustic microfluidic conduit in a portion of the fluid layer adjacent to the path.

In some examples, the adjusting at least one of the directing acoustic waves into the first or second ends of the waveguide to trap and manipulate particles in the acoustic microfluidic conduit is conducted without any physical boundary in the fluid layer. The waveguide control structure can be configured to trap at least one of particles having positive acoustic contrasts or particles having negative acoustic contrasts in the acoustic microfluidic chamber. In some examples, adjusting at least one of the directing acoustic waves into the first or second ends of the waveguide includes forming a moving Thouless pump arrangement in the acoustic microfluidic conduit.

In some examples, the waveguide control structure defines two or more waveguides that define a single acoustic microfluidic conduit. Directing acoustic waves into at least one of the first or second ends of the waveguide can include concentrating acoustic energy from an acoustic source using an acoustic lens arranged between the acoustic source and a respective one of the at least one of the first or second ends. In some examples, adjusting at least one of the directing acoustic waves into the first or second ends of the waveguide including forming a static or dynamic standing wave pattern along the microfluidic acoustic conduit. The particles in the fluid layer can be chosen from a group consisting of: biological tissues, cells, or cell products. In some examples, the at least one cavity is filled with a gas or contains a vacuum. In some examples, the fluid layer includes water and the solid material of the waveguide structure includes polydimethylsiloxane. In some examples, the acoustic microfluidic conduit defines a quasi-2D open chamber.

### BRIEF DESCRIPTION OF DRAWINGS

This disclosure will be more fully understood from the following detailed description taken in conjunction with the accompanying drawings, in which:

FIG. 1A is an illustration of an example of a microfluidic acoustic tweezer system according to the present disclosure;

FIG. 1B is an illustration of an example acoustic field present in a boundary-free microfluidic channel of the system of FIG. 1A;

FIG. 1C is a perspective cross-sectional view of the microfluidic acoustic tweezer system of FIG. 1A;

FIG. 1D is a cross-sectional view of the microfluidic channel and shadow waveguide structure of the microfluidic acoustic tweezer system of FIG. 1A;

FIG. 1E is a cross-sectional view of the microfluidic channel and shadow waveguide structure of FIG. 1D overlaid with an example acoustic field in the microfluidic channel;

FIG. 1F is a graph of frequency versus phase speed for the microfluidic channel and shadow waveguide structure of the microfluidic acoustic tweezer system of FIG. 1A;

FIG. 2A is a cross-sectional view of a dual-channel example of a microfluidic channel and shadow waveguide structure for use in a microfluidic acoustic tweezer system according to aspects of the present disclosure;

FIG. 2B is a cross-sectional view of the dual-channel structure of FIG. 2A overlaid with an example of a first mode of an acoustic field in the microfluidic channel;

FIG. 2C is a cross-sectional view of the dual-channel structure of FIG. 2A overlaid with an example of a second mode of an acoustic field in the microfluidic channel;

FIG. 2D is a graph of frequency versus phase speed for the first and second modes of the dual-channel structure of FIG. 2A;

FIG. 3A is a photograph is an example acoustic tweezer system with a linear channel;

FIG. 3B is a schematic of the acoustic tweezer system of FIG. 3A;

FIG. 3C is a photograph of the microfluidic channel of the acoustic tweezer system of FIG. 3A during operation;

FIG. 3D is a simulation of the pressure amplitude at the PDMS-water interface during the operation of the acoustic tweezer system shown in FIG. 3C;

FIG. 4A is a photograph of a dual-channel microfluidic channel of an acoustic tweezer system during operation;

FIG. 4B is a simulation of the pressure amplitude at the PDMS-water interface during the operation of the acoustic tweezer system shown in FIG. 3C;

FIG. 5A is a photograph is an example acoustic tweezer system with a curved channel;

FIG. 5B is a photograph of the microfluidic channel of the acoustic tweezer system of FIG. 5A during operation;

FIG. 5C is a simulation of the pressure amplitude at the PDMS-water interface during the operation of the acoustic tweezer system shown in FIG. 5C;

FIG. 6A is a schematic cross-sectional view of the layers of an example acoustic tweezer system;

FIG. 6B is is a schematic cross-sectional view of the microfluidic channel of the example acoustic tweezer system of FIG. 6B;

FIG. 7 is a schematic cross-sectional view of the layers and microfluidic channel arrangement of another example acoustic tweezer system;

FIG. 8A is a time sequence simulation of the manipulation of a captured particle through space and time within a Thouless pump arrangement of an acoustic tweezer system according to aspects of the present disclosure;

FIG. 8B is a time sequence of photographs showing particles pumped during a full cycle of a Thouless pump arrangement of an acoustic tweezer system according to aspects of the present disclosure;

FIG. 8C is a graph of particle pumping speed versus frequency detuning of the input fields of the simulated and real Thouless pump arrangements of FIGS. 8A and 8B;

FIG. 9A is a simulation of an example acoustic lens according to aspects of the present disclosure configured for use with a single channel acoustic tweezer; and

FIG. 9B is a simulation of another example acoustic lens according to aspects of the present disclosure configured for use with a dual channel acoustic tweezer.

### DETAILED DESCRIPTION

Certain exemplary embodiments will now be described to provide an overall understanding of the principles of the structure, function, manufacture, and use of the devices and methods disclosed herein. One or more examples of these embodiments are illustrated in the accompanying drawings. Those skilled in the art will understand that the devices and methods specifically described herein and illustrated in the accompanying drawings are non-limiting exemplary embodiments and that the scope of the present disclosure is defined solely by the claims. The features illustrated or described in connection with one exemplary embodiment may be combined with the features of other embodiments. Such modifications and variations are intended to be included within the scope of the present disclosure. In the present disclosure, like-numbered components and/or like-named components of various embodiments generally have similar features when those components are of a similar nature and/or serve a similar purpose, unless otherwise noted or otherwise understood by a person skilled in the art.

The figures provided herein are not necessarily to scale. Still further, to the extent arrows are used to describe a direction of movement, these arrows are illustrative and in no way limit the direction the respective component can or should be moved. A person skilled in the art will recognize other ways and directions for creating the desired result in view of the present disclosure. Additionally, a number of terms may be used throughout the disclosure interchangeably but will be understood by a person skilled in the art.

To the extent the present disclosure includes various terms for components and/or processes of the disclosed devices, systems, aircraft, methods, and the like, one skilled in the art, in view of the claims, present disclosure, and knowledge of the skilled person, will understand such terms are merely examples of such components and/or processes, and other components, designs, processes, and/or actions are possible.

Articles “a” and “an” are used herein to refer to one or to more than one (e.g., at least one) of the grammatical object of the article. By way of example, “an element” means at least one element and can include more than one element. “About” is used to provide flexibility to a numerical range endpoint by providing that a given value may be “slightly above” or “slightly below” the endpoint without affecting the desired result. The use herein of the terms “including,” “comprising,” or “having,” and variations thereof, is meant to encompass the elements listed thereafter and equivalents thereof as well as additional elements. As used herein, “and/or” refers to and encompasses any and all possible combinations of one or more of the associated listed items, as well as the lack of combinations where interpreted in the alternative (“or”). As used herein, the transitional phrase “consisting essentially of” (and grammatical variants) is to be interpreted as encompassing the recited materials or steps “and those that do not materially affect the basic and novel characteristic(s)” of the claimed invention. Thus, the term “consisting essentially of” as used herein should not be interpreted as equivalent to “comprising.” Moreover, the present disclosure also contemplates that in some embodiments any feature or combination of features set forth herein can be excluded or omitted. To illustrate, if the specification states that a complex comprises components A, B and C, it is specifically intended that any of A, B or C, or a combination thereof, can be omitted and disclaimed singularly or in any combination.

Recitation of ranges of values herein are merely intended to serve as a shorthand method of referring individually to each separate value falling within the range, unless otherwise indicated herein, and each separate value is incorporated into the specification as if it were individually recited herein. For example, if a concentration range is stated as 1% to 50%, it is intended that values such as 2% to 40%, 10% to 30%, or 1% to 3%, etc., are expressly enumerated in this specification. These are only examples of what is specifically intended, and all possible combinations of numerical values between and including the lowest value and the highest value enumerated are to be considered to be expressly stated in this disclosure.

Unless otherwise defined, all technical terms used herein have the same meaning as commonly understood by one of ordinary skill in the art to which this disclosure belongs. The use of acoustic tweezers to manipulate micro- and nanoscale particles is a rapidly expanding field. There are several conventional approaches to trapping and moving these particle, each having strengths and weaknesses. Typical drawbacks include limited particle selectivity and path definition, limited flow rates and operating ranges, high system complexity and fragility, and potential damage to the particles of interest.

Illustrative embodiments disclose acoustic tweezers for particle trapping and manipulation. This may be accomplished using a structure just outside the chamber that can guide and control the acoustic wave fields inside the chamber. The fields can advantageously be achieved with only two sources and without requiring any structure inside the chamber. In this way, trapping and transport patterns can be generated that are impossible to achieve with a traditional source array.

One aspect of the present disclosure is an acoustic tweezer device that includes a microfluidic cavity and boundary control elements that are completely external to the microfluidic cavity. Particle movement can be controlled exclusively by the boundary control elements and associated components (e.g., acoustic transducers).

In the context of the present disclosure, the boundary control elements can be referred to as a “waveguide control structure.” That is, an external structure can be designed to direct and concentrate the acoustic wave energy in an adjacent fluid layer. The waveguide control structure is also be referred to herein as a “shadow structure” since no physical boundary need be present inside the quasi-2D microfluidic open chamber functionally formed in the fluid layer by the acoustic waves, and the acoustic fields, particle trapping, and particle transport can follow a path of the waveguide control structure along and adjacent to the fluid layer. Further, the waveguide control structure can refer to all functional aspects of any features that influence the waveform. This includes, but is not limited to, the geometric shape or other topological features, the minimum and overall material thickness of the waveguide material, add-on features, and characteristics of the interface between the waveguide material and the fluid, cavity, and/or substrate. The waveguide control structure can have several embodiment types, including any structure outside the microfluidic chamber that provides not only waveguides, but also other functionalities such as lenses, resonators, etc.

Illustrative embodiments demonstrate an acoustic tweezer capable of generating a highly confined and selective trapping path of almost arbitrary spatial complexity inside an open chamber without any interior structure. The spatial pattern of the acoustic field may be controlled by a waveguide control structure completely exterior to the fluid layer and create a trapping and transport geometry that would be exceedingly difficult to generate only through sources on the chamber boundary. By engineering the mode shape inside the waveguide, manipulation of particles with both positive and negative contrasts along predefined narrow and complex paths can be achieved.

Examples of the present disclosure provide advantages and new possibilities to acoustic tweezers. Compared with conventional acoustic tweezers that can an array of sources to create standing wave patterns along Cartesian or cylindrical coordinates, examples of the present disclosure can guide acoustic waves in more versatile and selective spatial distributions and thereby achieve 2D and quasi-3D particle manipulation along complicated paths with only one pair of transducers. Additionally, particles can be confined to a single thin path without the existence of a physical boundary. Examples of the present disclosure thus circumvents some of the drawbacks of physical microfluidic channels, such as limited flow rates for a given pressure drop and the need for sheath flow to prevent particle jamming. The lack of physical boundary with examples of the present disclosure also allows interaction and information exchange between the trapped particles, such as cells and bacteria, and their environment. And compared with previous efforts to control sound propagation in microfluidic chambers using phononic crystals, examples of the present disclosure enable a much wider range of guided mode shapes with little dispersion, unlocking the possibility of more advanced particle manipulation.

Examples include broadband waveguides that enable the creation of complex time-varying acoustic actuation. Examples also include more complex time-varying functionalities for example, created by synthesizing the potential input fields with a systematic approach to synthesize arbitrary time-dependent potential wells for acoustic tweezers. In addition, the mode shape engineering demonstrated is applicable in many additional ways contemplated by this disclosure.

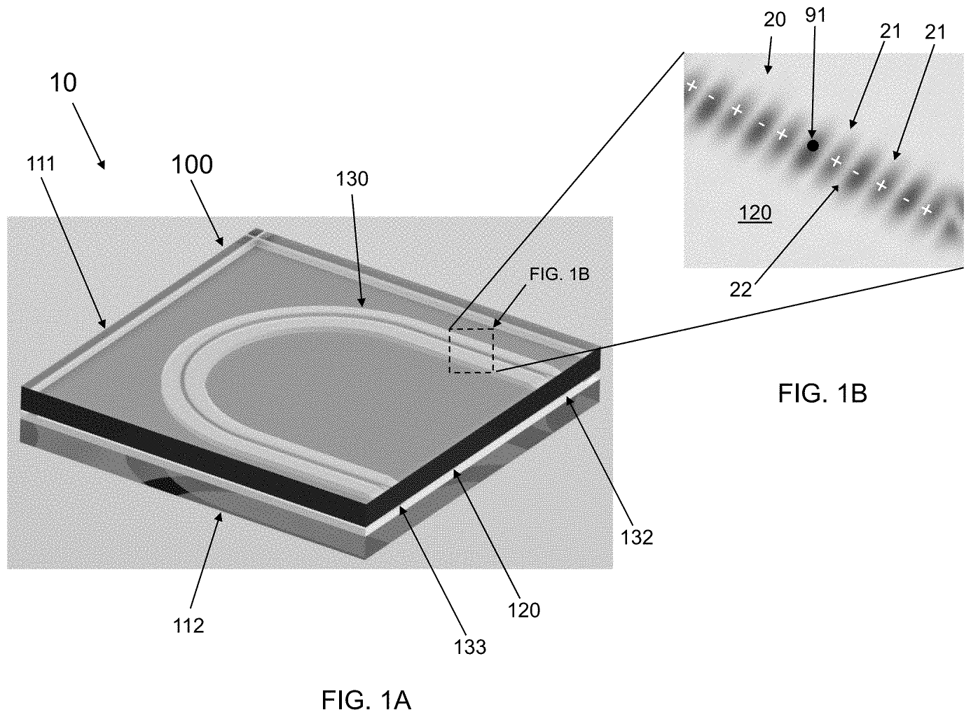

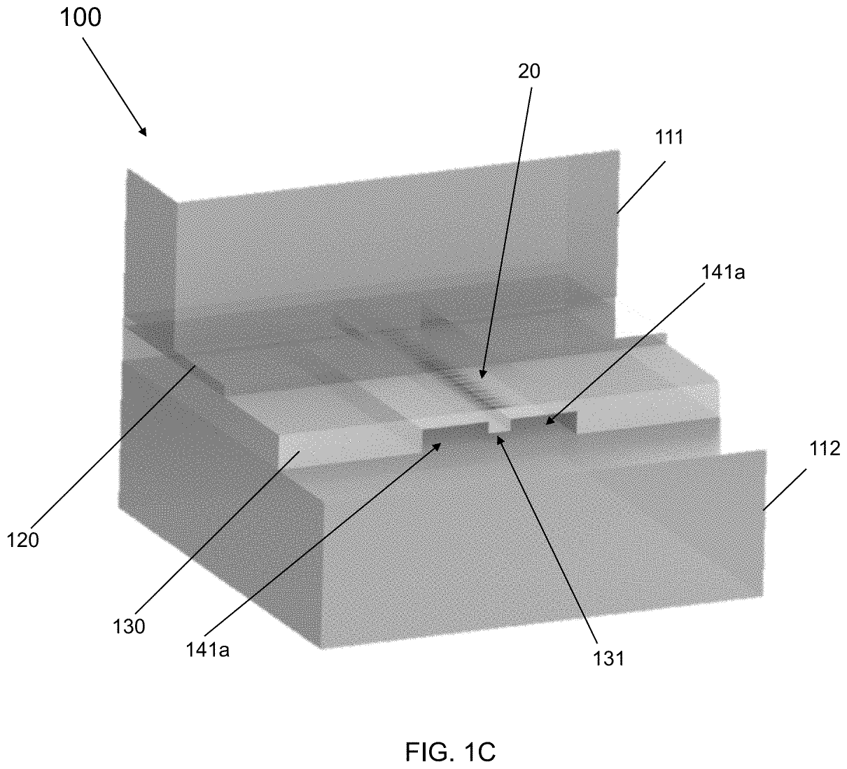

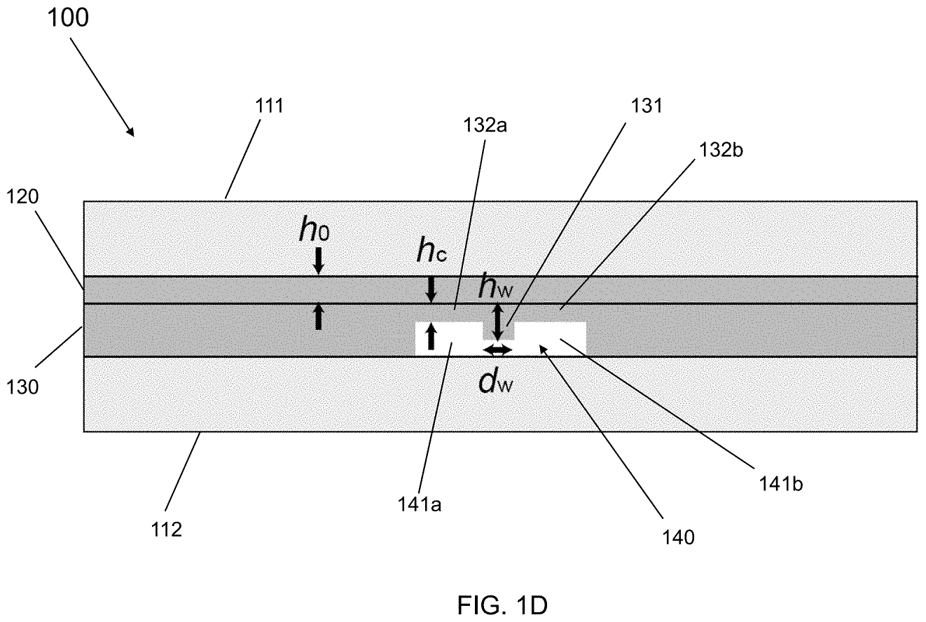

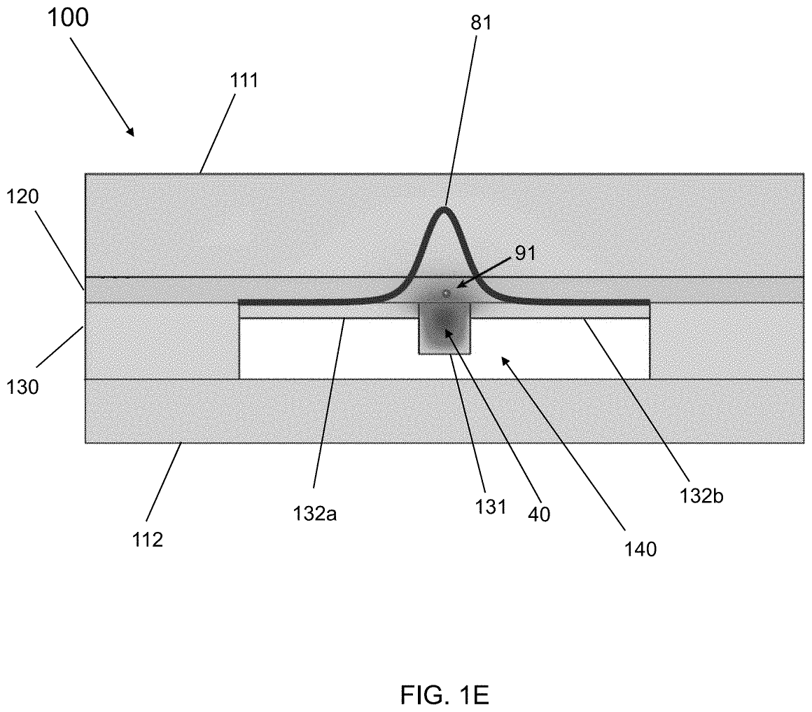

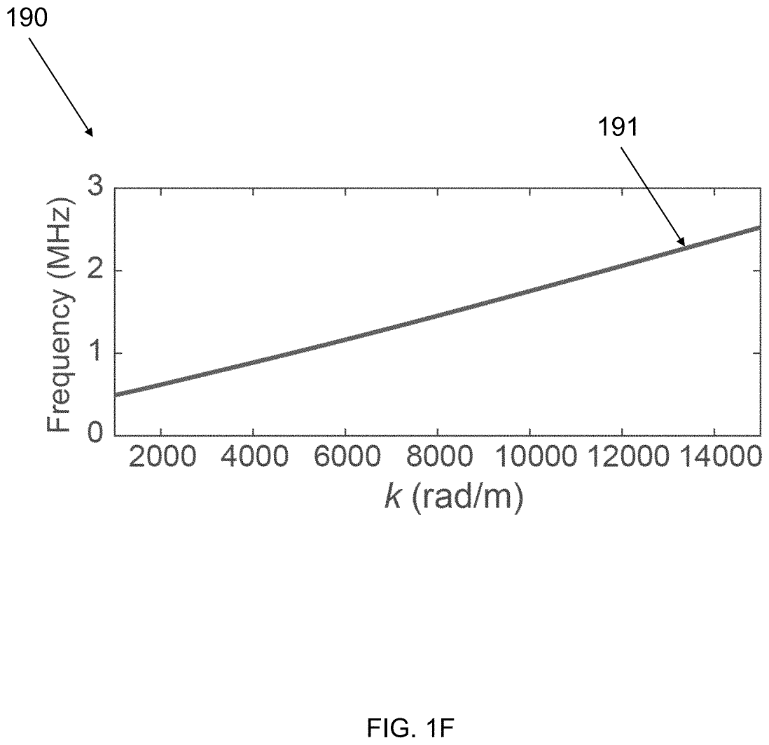

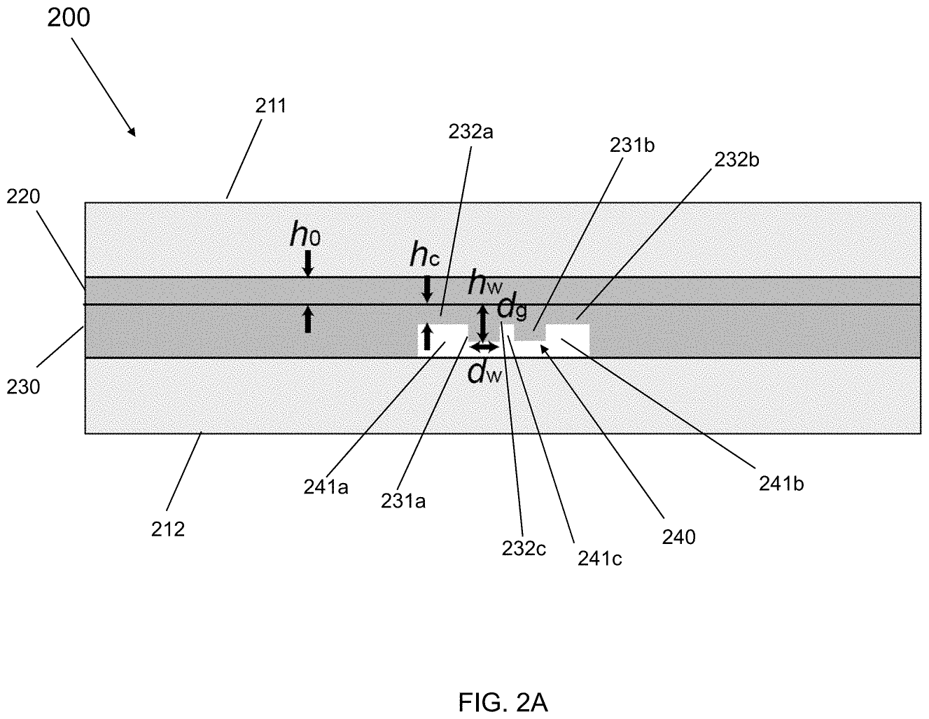

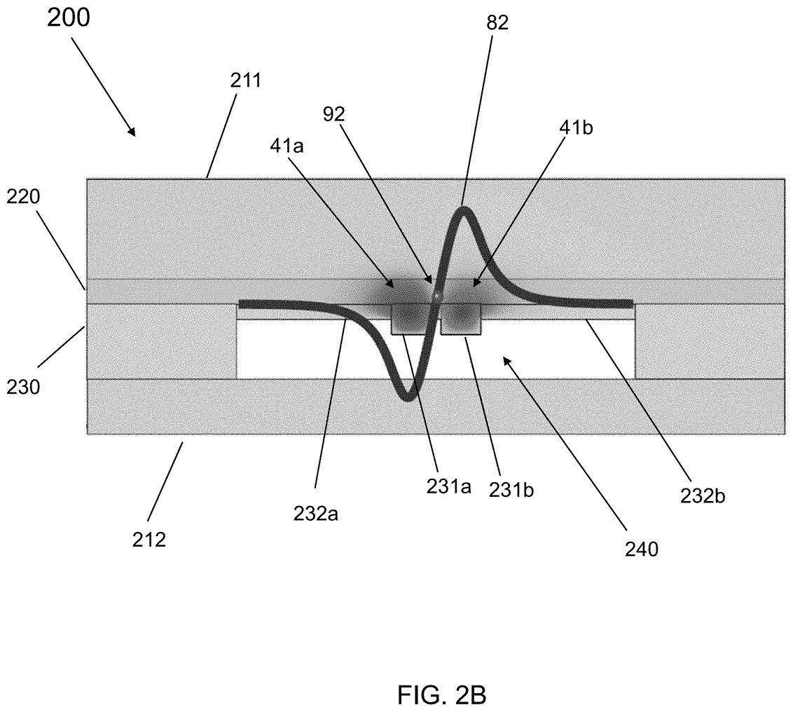

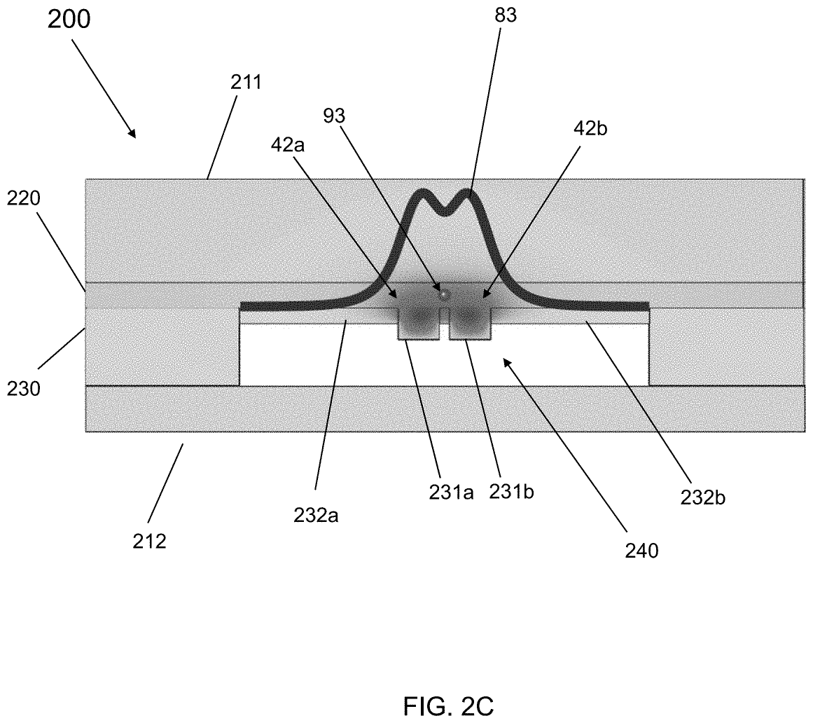

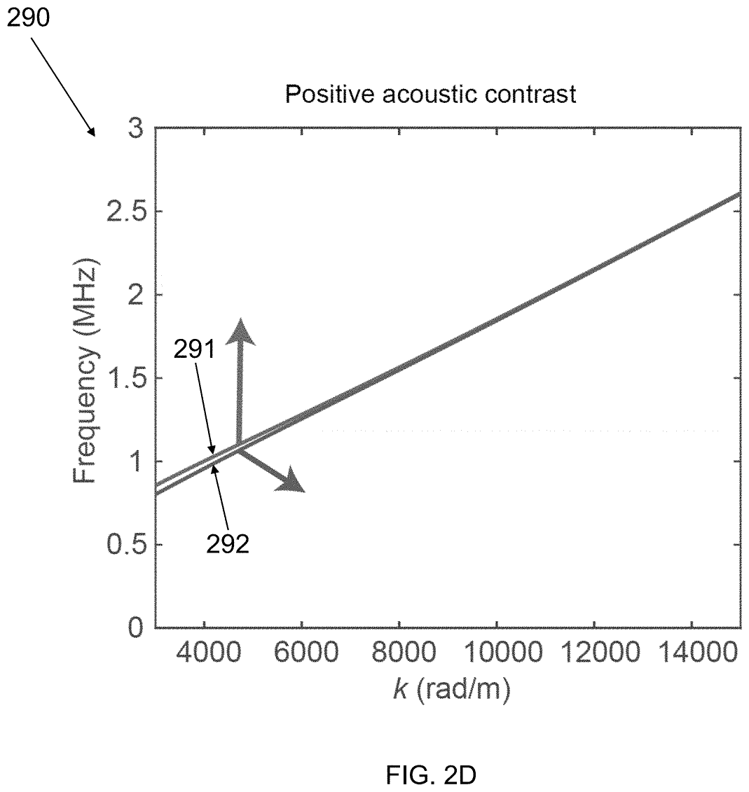

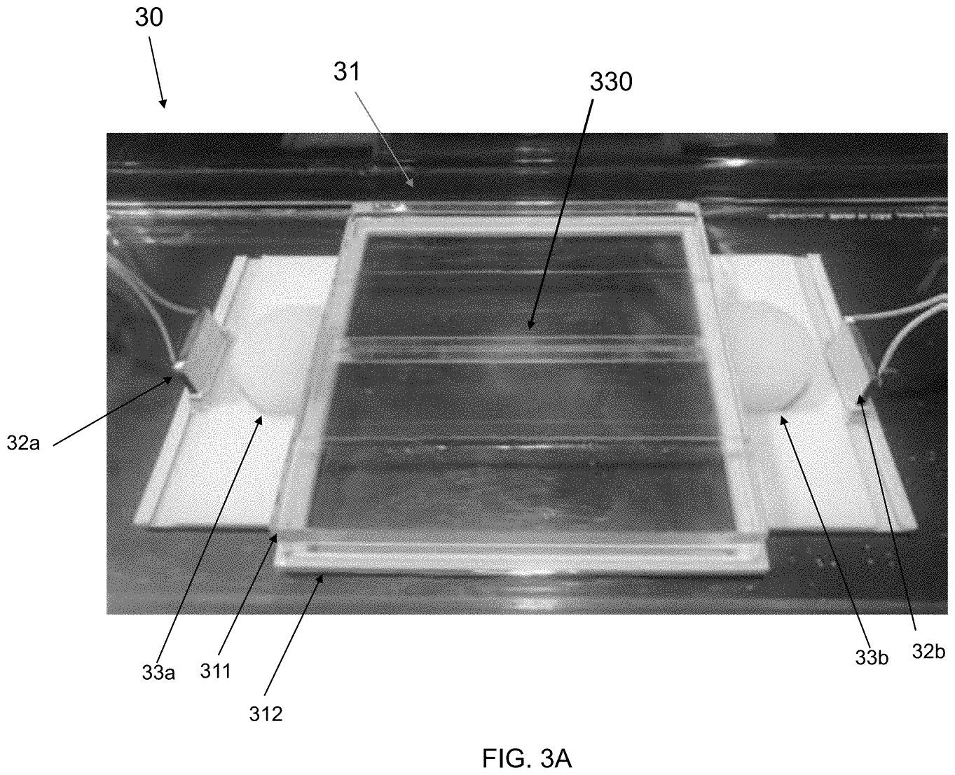

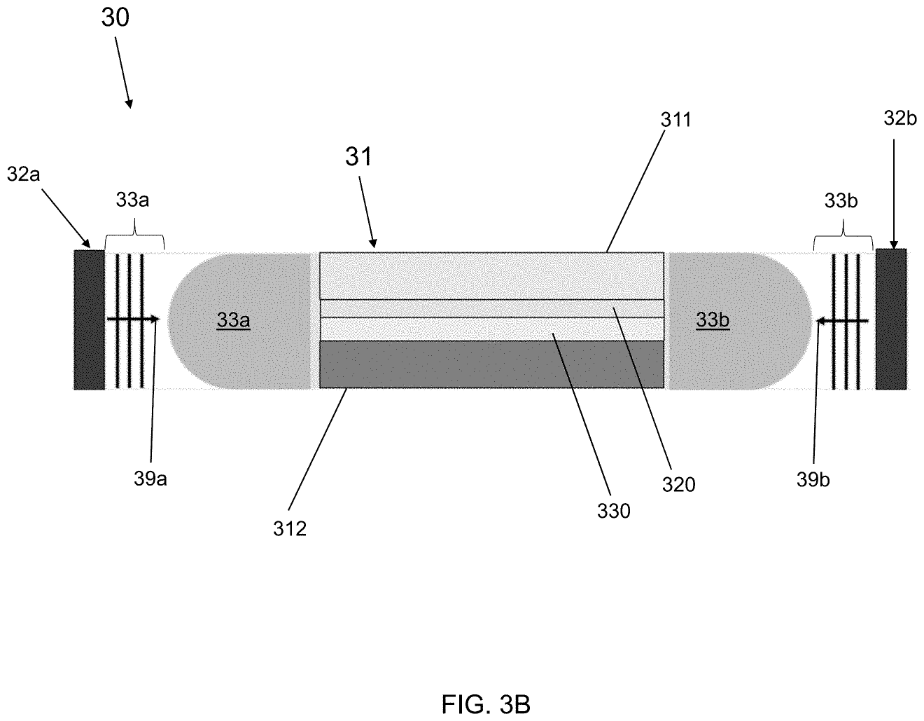

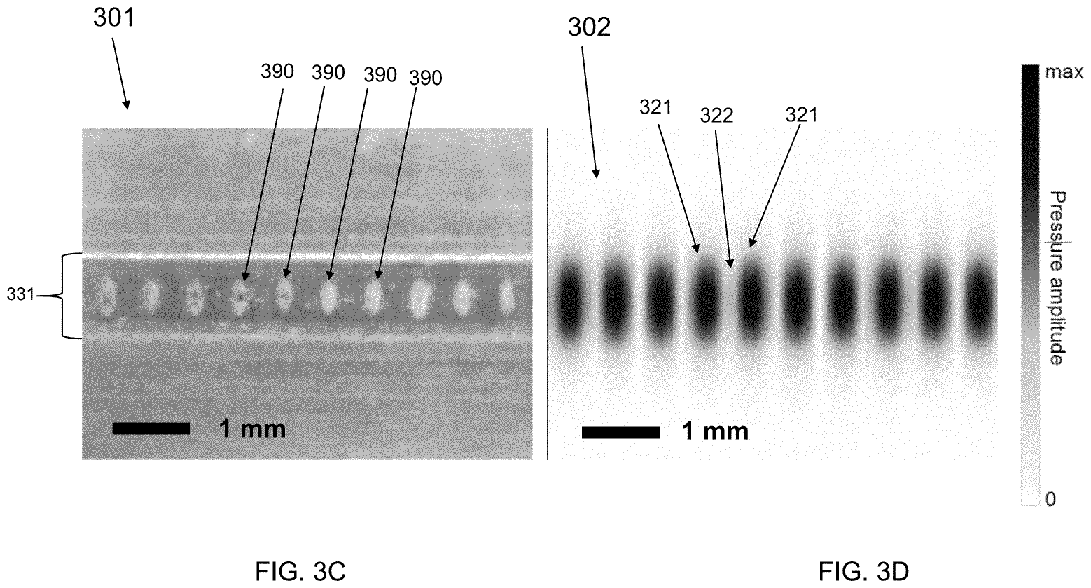

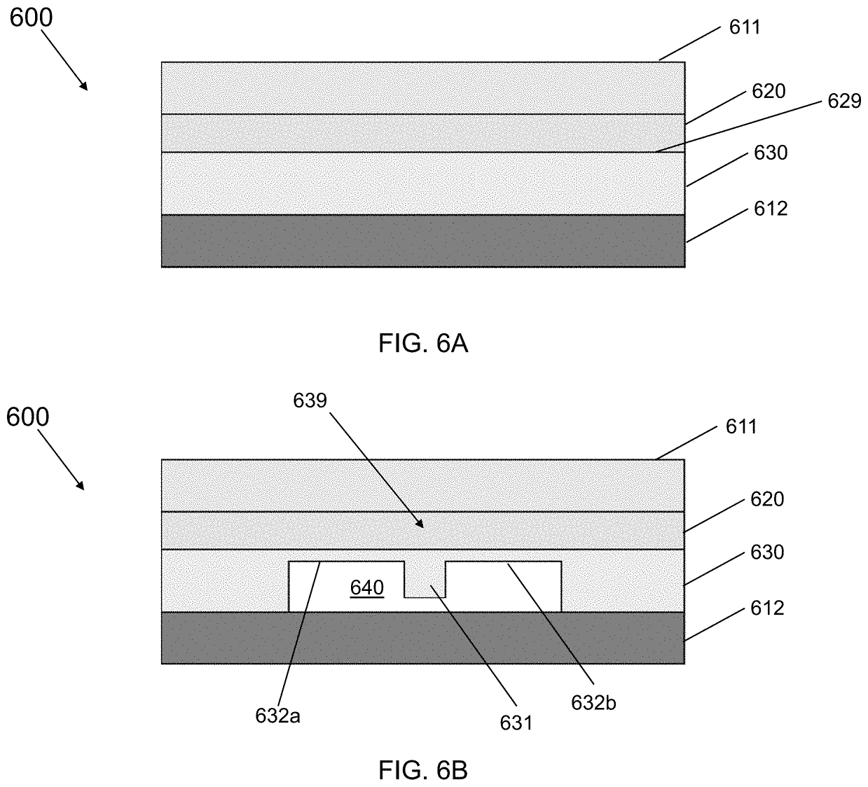

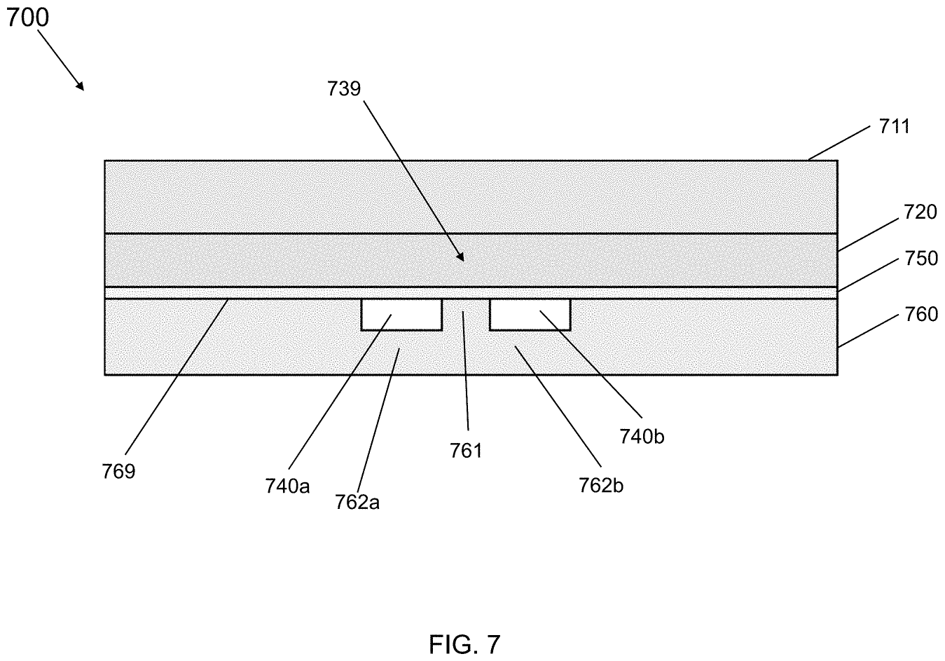

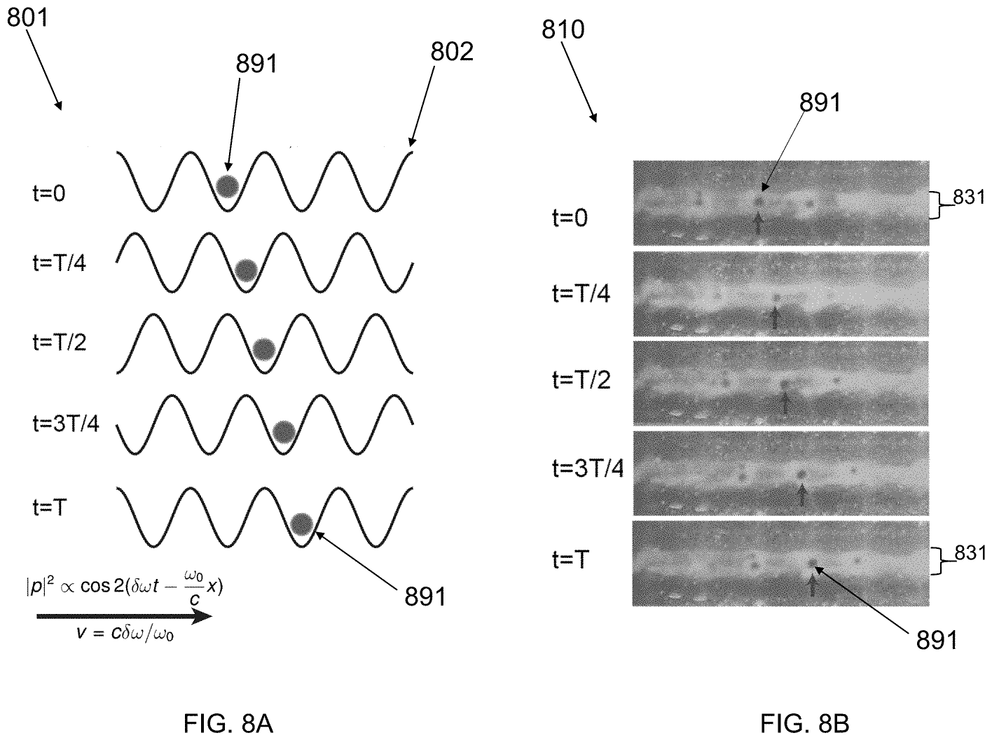

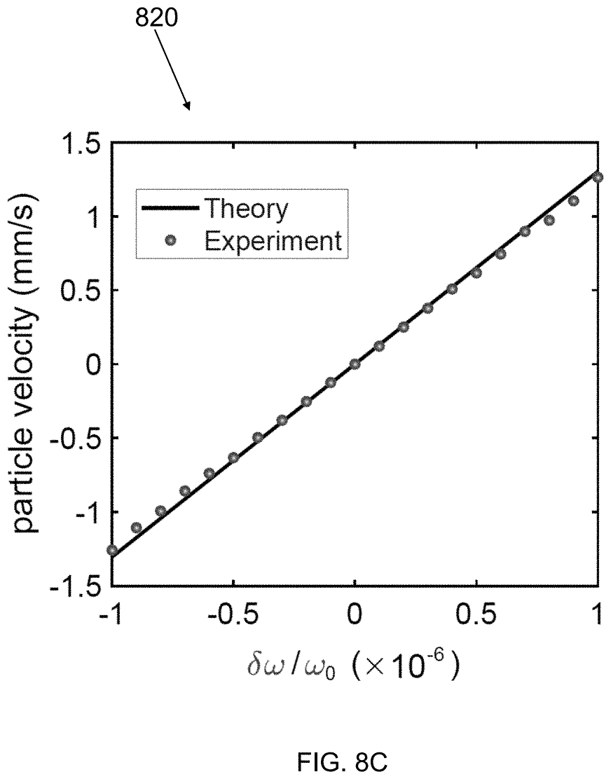

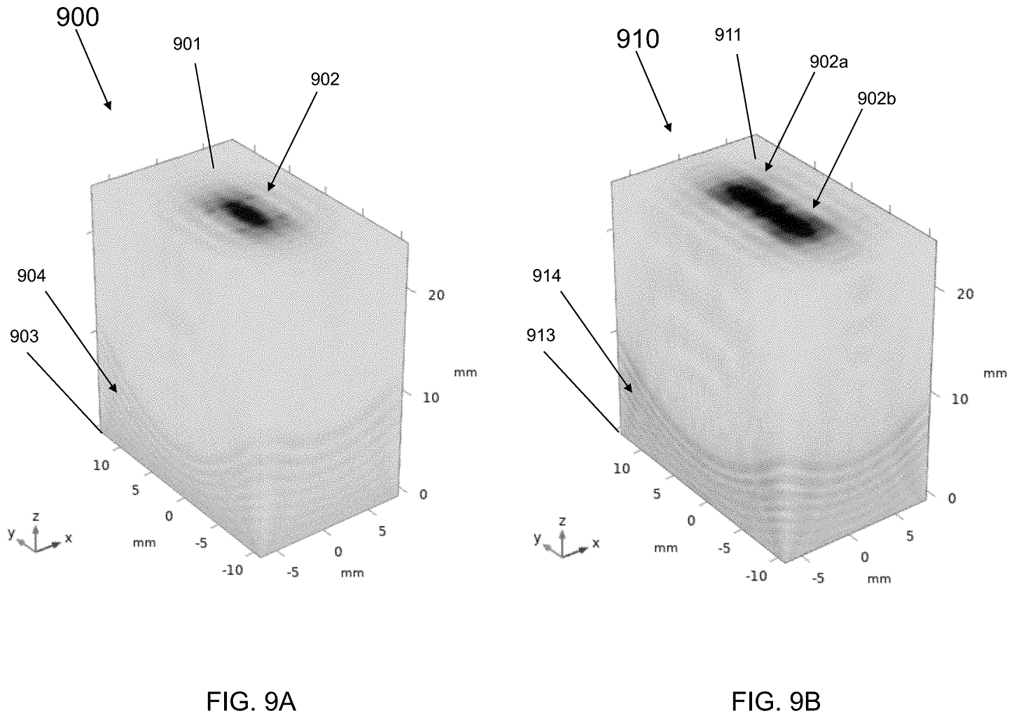

FIGS. 1A-1F show an example acoustic tweezer device with a waveguide that is configured to form a single elongated quasi-2D microfluidic open chamber (also referred to herein as an acoustic microfluidic conduit) in a fluid layer disposed adjacent to the waveguide. FIGS. 2A-2D show an example acoustic tweezer device with a waveguide configured to form two parallel acoustic microfluidic conduits. FIGS. 3A-5C show three different acoustic tweezer systems, with experimental results and corresponding simulations of the acoustic pressure in the acoustic microfluidic conduit(s). FIGS. 6A-7 show cross-sections of different arrangements of the layers of example acoustic tweezer devices. FIGS. 8A-8C show simulations and experiments results of a novel way of operating an acoustic tweezer device as an acoustic Thouless Pump. And FIGS. 9A and 9B show simulations of two different acoustic lenses that can be used to inject acoustic energy into the waveguides of acoustic tweezer devices according to aspects of the present disclosure.

### Acoustic Tweezer Devices—Single Channel

FIGS. 1A and 1C show an acoustic tweezer system 10 that includes a particle 91, a microfluidic device 100, and two sources of acoustic energy (not shown) according to one embodiment of the present disclosure. The microfluidic device 100 includes a fluid layer 120 bounded on one side by a solid material (e.g., glass) top layer 111 and on the opposite side by a waveguide control structure 130. In some embodiments, the waveguide structure layer 130 is supported by a bottom substrate 112. The substrate 112 can be any solid material (e.g., glass) and can be used to support the device 100 mechanically. The waveguide control structure 130 forms a path (e.g., U-shaped, as shown in FIG. 1A) along (e.g., under) the fluid layer 120 that creates a path for acoustic energy to travel along, which can extend, for example, from a first end 132 of the waveguide control structure 130 to a second end 132. The ends 132, 133 can be locations where acoustic energy is provided to the system, for example, by acoustic sources (e.g., piezoelectric transducers), and the system can further includes acoustic lenses to concentrate and direct acoustic energy from the acoustic sources into a waveguide portion 131 (as shown in more detail in FIG. 1D) of the waveguide control structure 130. In operation, and as shown in FIG. 1B, acoustic energy in the waveguide control structure 130 can create an acoustic tweezer 20 in the fluid layer 120 that includes alternating positive 21 and negative 22 acoustic waves, in which a particle 91 can be controlled (e.g., trapped or moved) along the path of the waveguide portion 131 of the waveguide control structure 130. The path of the waveguide portion 131 of the waveguide control structure 130 creates, when acoustic energy is applied, an acoustic microfluidic conduit in the region of the fluid layer closest to the waveguide portion 131. The acoustic microfluidic conduit in the fluid layer 120 is an acoustic tweezer 20 along which the particle(s) 91 can be manipulated. Notably, because the waveguide control structure 130 is disposed adjacent to (e.g., below, as shown) the fluid layer 120, the fluid layer 120 can be uninterrupted and the 2D movement of particles 91 in the plane of the fluid layer 10 can be completely controlled by the acoustic energy applied to the ends 132, 133 of the waveguide control structure 130.

In a representative embodiment (and as shown in experimental results herein), the top layer 111 is a glass plate, and the waveguide control structure 130 is formed of polydimethylsiloxane (PDMS). Other materials can also be used and one of ordinary skill in the art will appreciate that the relative densities and a desired acoustic contrast of the system can help determine material choices. The fluid layer 120 may be bounded at a prescribed height, and it can be any suitable width. In some embodiments, the fluid layer 120 can have a thickness in the range of approximately 100-1000 μm and a width that is semi-infinite or “open” (e.g., without internal structures, walls, channels, or boundaries), such that trapped particles do not come into contact with any physical obstacles within the fluid. The lack of physical boundaries within the fluid layer advantageously allows interaction and information exchange between the trapped particles.

FIG. 1C shows a representative cross-sectional view of the device 100 taken perpendicular to a path of the waveguide of the waveguide control structure 130, with the layers cut at different depths to better illustrate the arrangement. The device 100 includes the top layer 111 (e.g., glass plates) and waveguide structure layer 130 (e.g., a layer of structured PDMS) which bound the fluid layer 120, in which a microfluidic chamber is formed by the acoustic field (depicted by, for example, black line 81 in FIG. 1E) when in operation. The acoustic field in the microfluidic chamber in the fluid layer 120 is controlled through interaction with the structure layer 130 that is disposed outside the fluid layer 120, this structure layer 130 is also referred to herein as a shadow waveguide. The particles 91 in the microfluidic chamber may be constrained by the shadow waveguide and can thus be confined and manipulated without a physical boundary. Visible in FIG. 1C is a path-forming structure within the waveguide control structure 130 that forms a waveguide 131 situated within the waveguide structure layer 130. The waveguide 131 is bounded, at least partially, by a secondary region 140, which includes two lateral portions 141a and 141b that define a width of the waveguide 131. In some examples, and as shown, the secondary region 140 extends below the waveguide 131 (e.g., connecting the lateral portion 141a, 141b) to define a thickness of the waveguide 131. The secondary region 140 can include any suitable environment, such as air, gas, vacuum, or other materials that are softer and lighter than water. Functionally, the secondary region 140 creates an acoustic contrast between both the waveguide 131 and the fluid layer 121, thereby enabling acoustic energy to be directed along the waveguide 131 and into the fluid layer 120 adjacent to the waveguide 131 (e.g., along a side of the waveguide not bounded by the secondary region 140) to form the acoustic tweezer 20.

In FIGS. 1D and 1E, a cross sectional view of the device 100 and FIG. 1E shows the mode shape of the acoustic energy delivered by the waveguide 131 to trap particles and operate the acoustic tweezer 20. In FIG. 1D certain geometric parameters are labeled to provide an example of the device 100. The waveguide control structure 130 includes two lateral bounding regions 132a and 132b that bound the waveguide portion 131 of a particular height h_{w} and width d_{w}. The lateral bounding regions 132a and 132b have a height h_{c} less than the height h_{w} of the path-forming structure 131. These lateral bounding regions 132a and 132b may tightly confine the acoustic field along a complex path inside the microfluidic chamber but no physical boundary is present inside the chamber. The thickness (h₀) of the fluid layer 120 is indicated, which can be about 500 μm, and a non-limiting representative range for the thickness of the fluid layer can be about 10 μm to about 5000 μm. The thickness (h_{w}) of the waveguide 131 is indicated, which can be about 1000 μm, and a non-limiting representative range for the thickness of the waveguide can be about 10 μm to about 3000 μm. The width (d_{w}) of the waveguide 131 is also indicated, which can be about 1000 μm, and a non-limiting representative range for the width of the waveguide can be about 20 μm to about 2000 μm. Finally, the thickness (h_{c}) of the waveguide structure layer 130 between the lateral portions 141a, 141b of the secondary region 140 is indicated, which can be about 300 μm and a non-limiting representative range for the thickness of the waveguide structure adjacent to the waveguide can be about 3 μm to about 2000 μm.

The acoustic contrast (e.g., difference in density and/or speed of sound) between the waveguide control structure 130 and the secondary region 140 creates an effective index profile to guide the waves. A non-limiting representative range for the mass density of the material of the secondary region 140 is about 10 times less than the density of waveguide control structure 130 material to a complete vacuum with zero mass density. At the interface between two media with different refractive indices, total internal reflection occurs when the incident angle is above the critical angle. Wave propagation can thus be confined along a narrow channel by wrapping a high index material (e.g., the core or waveguide 131) with a low index material (e.g., the cladding or secondary region 140). The effective index can be controlled by the height of the waveguide structure layer 130 and/or the waveguide 131 (e.g., a thicker waveguide and/or waveguide structure layer results in slower effective sound speed in the fluid layer). Therefore, in some embodiments, the acoustic field inside the fluid layer 120 is guided by the waveguide structure layer 130 that is fully outside the fluid layer 120. The strength of the acoustic field (depicted as shaded region 40) along the interface of the fluid layer 120 and waveguide control structure 130 is represented in FIG. 1E by a curve 81 that corresponds to the pressure amplitude distribution at the interface. FIG. 1E further depicts a particle 91 within the acoustic field as it travels along the microfluidic acoustic conduit in the fluid layer 120 that is formed by the acoustic energy directed through the adjacent waveguide 131. The acoustic field can be controlled by two sources (e.g., acoustic transducers, not shown, disposed on opposite ends 132, 133 of the waveguide 133) of acoustic energy, which create a highly localized mode and can utilize a wide range of frequencies.

The surface of the material of the waveguide control structure 130 facing the fluid layer 120 can be generally planar. In the example device 100 of FIGS. 1A-1F, an opposite side (e.g., not facing the fluid layer 120) of the waveguide control structure 130 includes waveguide features (e.g., waveguide 131) and a cavity (e.g., secondary region 140) that is formed between the waveguide control structure 130 and a structural substrate 112. The surface of the waveguide control structure 130 can be directly adjacent to the fluid layer 120 or a thin membrane can be disposed between the waveguide control structure 130 and the fluid layer 120.

In operation, the waveguide 131 can create a highly selective acoustic tweezer 20 that traps and manipulates particles 91 along a thin, single predefined but complex path through the fluid layer 120 (e.g., a microfluidic acoustic conduit). The device 100 can be broadband, which greatly enriches the versatility of acoustic tweezers by unlocking arbitrary and complex input waves that form the acoustic tweezer 20. The mode shape of the acoustic wave in the waveguide 131 may accommodate particles with positive, negative, or both positive and negative acoustic contrasts. In exemplary embodiments, precise control of the position and velocity of trapped particles 91 within the fluid layer 120 can be achieved by frequency detuning two sources to form potential wells moving at a controlled speed, analogous to Thouless pumping for quantized charge transport, as shown in FIGS. 8A-8C and discussed in more detail below.

In certain embodiments, the acoustic field can be analyzed by the full-wave eigenfrequency simulation through COMSOL Multiphysics, Pressure Acoustics module. Perfect Matching Layers can be used on the left and right sides of the simulation domain. An out-of-plane wavenumber can be assigned, and then the eigenmodes can be solved by finding the eigenfrequency around an estimated value. Then the out-of-plane wavenumber can be swept to calculate the ω-k diagram.

Referring back to FIG. 1E, the curve 82 denotes the pressure distribution along the interface between the waveguide structure layer 130 and fluid layer 120. In some embodiments, the curve is tightly confined in the core of the waveguide 131 and decays exponentially away from its center. Exemplary waveguide designs can trap and manipulate negative acoustic contrast particles that are attracted to pressure maxima. The corresponding dispersion relation graph 190 is shown in FIG. 1F. The linear dispersion 191 indicates a waveguide 131 can support a wide range of frequencies with the same group velocity. This broadband property can be exploited for the generation of complex potential profiles in both space and time, which can in turn lead to sophisticated control of particles and more capable acoustic tweezers.

In some embodiments, the waveguide control structure can be configured for trapping particles with positive or negative acoustic contrasts. In addition to the characteristics of the waveguide 131 features disposed at a cross-sectional instance of the device 100, the waveguide 131 can have a perpendicular or axial component that defines a trajectory of trapped particles 91. A standing wave pattern can be created along the path of the waveguide 131 with respect to the fluid layer 120, which defines a narrow, virtual “conduit” along which particles 91 move (e.g., the acoustic tweezer 20). One advantage of the presently disclosed devices is that it is not necessary to have a straight trajectory for the particle path. It is possible to configure the path of the waveguide 131 with respect to the fluid layer 120 to create a trajectory that moves particles anywhere within the confines of the fluid layer 120. Additionally, and because the waveguide 131 is external to the fluid layer 120, the direction of the path can be extremely versatile compared to conventional solutions. For example, the device 100 of FIG. 1C has a U-shaped path. Further, a waveguide of the waveguide control structure 130 can be provided along a desired trajectory in numerous different ways. In some embodiments, the waveguide can be formed as a single cross-sectional shape that extends continuously along the length of the trajectory, or it can have a profile that transforms in a smooth or discrete manner along the length. Alternately, the waveguide can be provided at prescribed intervals.

As mentioned hereinabove, the waveguide control structure 130 can be provided in several different ways. It is to be noted that, although the example provided in FIGS. 1A-1E are described as a device 100 with a prescribed geometry, other embodiments are also possible. For example, the waveguide control structure 130 can be provided as point or structure arrays employing phononic crystals, as a surface treatment, or as a positive or negative surface pattern. Other examples of alternate embodiments are described herein.

### Acoustic Tweezer Devices—Dual Channel

In many acoustic tweezer application, specifically biomedical applications, particles (e.g., cells), have a positive acoustic contrast and thus are attracted to pressure minima. Examples include a waveguide device 200 that can accommodate these particles by creating local pressure minima through mode shape engineering using a dual-channel microfluidic acoustic conducti created by forming two waveguides in close proximity in a waveguide control structure. FIGS. 2A-2D illustrate a dual-channel example of a microfluidic channel and shadow waveguide structure for use in a microfluidic acoustic tweezer system according to aspects of the present disclosure. FIGS. 2A-C show cross-sections of the dual-channel waveguide structure and FIG. 2D is a graph of frequency versus phase speed for the first and second acoustic modes.

In FIG. 2A, an acoustic tweezer device 200 is arranged similarly to the device 100 of FIGS. 1A-1F, but utilizes two path-forming waveguide structures 231a, 231b within a waveguide control structure 230. The device 200 comprises a fluid layer 220 bounded on one side by a solid material 211 (e.g., a top layer, which could be glass or another transparent material to facilitate visualization of the fluid layer 220), and bounded on an opposite side by the waveguide control structure 230. The waveguide structure layer 230 can be supported by a substrate 212, as shown. The two path-forming waveguide structures 231a and 231b can be formed within the waveguide structure layer 230 (e.g., of the same solid material or of a different material) and are partially bounded by a secondary structure layer 240, that includes of three regions 241a, 241b, and 241c of a certain thickness within the waveguide structure layer 230 to define the shape of the waveguides 231a, 231b and create a positive acoustic contrast. Arranged adjacent to the waveguides 231a, 231b are thinner bounding regions 232a-c of the waveguide control structure 230 that connect the waveguide structure layer 230 and are of a lesser height (e.g., thickness) than the waveguides 231a, 231b. As shown, the secondary region 240 extends under (relative to the view) the waveguides 231a, 231b and the thinner bounding regions 232a-c, and includes three regions 241a, 241b, and 241c of increased thickness that define therebetween the two portions of the waveguide control structure 230 that form the waveguides 231a, 231b. Dimensionally, a middle region 241c separates the waveguides 231a, 231b with a width (d_{g}) that can be less than the width (d_{w}) of each individual waveguide 231a, 231b. Accordingly, the three bounding regions 232a-c that flank the waveguides 231a, 231b also define a particular height (h_{c}) and width. As shown, the bounding regions 232a-c have height less than the height of the waveguides 231a, 231b. As shown in FIGS. 2B and 2C, these bounding regions 232a-c in combination with the secondary structure 240 confine the acoustic field along the waveguides 231a, 231b in a complex path that extends inside the fluid layer 220 without a physical boundary.

In illustrative embodiments, the thickness (h₀) of the fluid layer 220 can be about 500 μm, and a non-limiting representative range can be about 10 μm to about 5000 μm. The thickness (h_{w}) of each waveguide 231a, 231b can be about 600 μm, and a non-limiting representative range can be about 10 μm to about 3000 μm. The width (d_{w}) of each waveguide 231a, 231b can be about 800 μm, and non-limiting representative range can be about 20 μm to about 2000 μm. The width (d_{g}) of the waveguide control structure 230 between the waveguides 231a, 231b can be about 200 μm and a non-limiting representative range can be about 10 μm to 1000 μm. Finally, the thickness (h_{c}) of the bounding regions 232a-c can be about 300 μm and non-limiting representative ranges can about 3 μm to about 2000 μm.

FIGS. 2B-2C depict the cross-sectional view of FIG. 2A with two different modes of an acoustic field in the waveguides 231a, 231b and adjacent portions of the fluid layer 220. FIG. 2B depicts an anti-symmetric mode, with a negative acoustic energy field (represented by shaded region 41a) and a positive acoustic energy (represented by shaded region 41b) trapping a particle 92 in an acoustic gradient (represented by line 82) within the fluid layer 220. In FIG. 2C, two positive acoustic fields (represented by shaded regions 42a and 42b) trap a particle 93 in an acoustic field minimum (represented by line 83) within the fluid layer 220. Despite the different mode shapes of the acoustic fields of FIGS. 2B and 2C, FIG. 2D shows a representative graph 290 of substantially similar frequency versus phase speed for the modes. Line 291 represents the mode of FIG. 2B and line 292 represents the mode of FIG. 2C. By controlling the geometrical parameters, the mode shape can thus be engineered to create a local minimum with controlled width and depth, where particles 93 with positive contrast can be trapped and manipulated.

### Acoustic Tweezer Systems

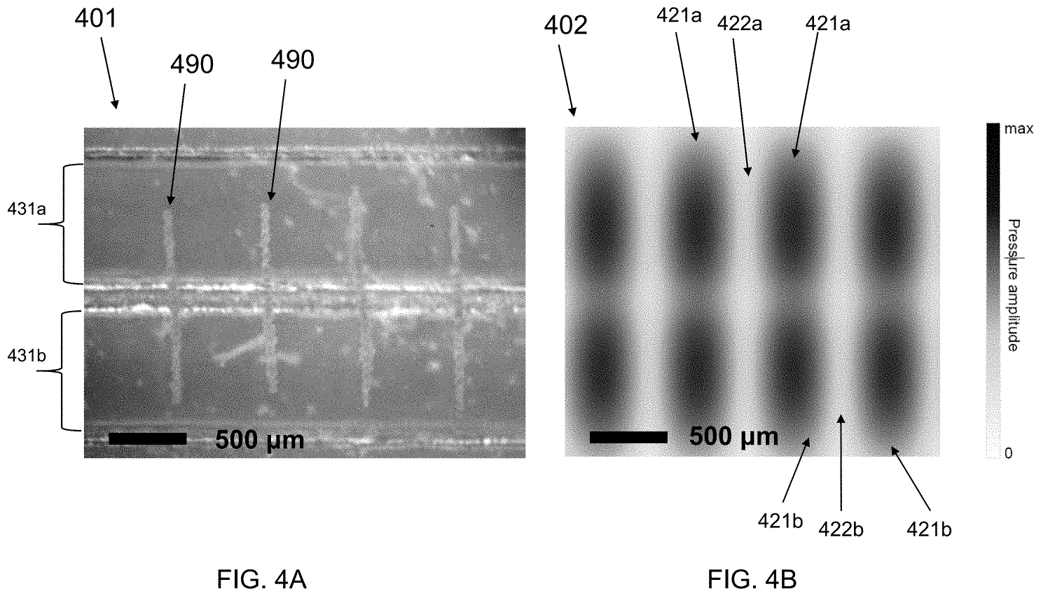

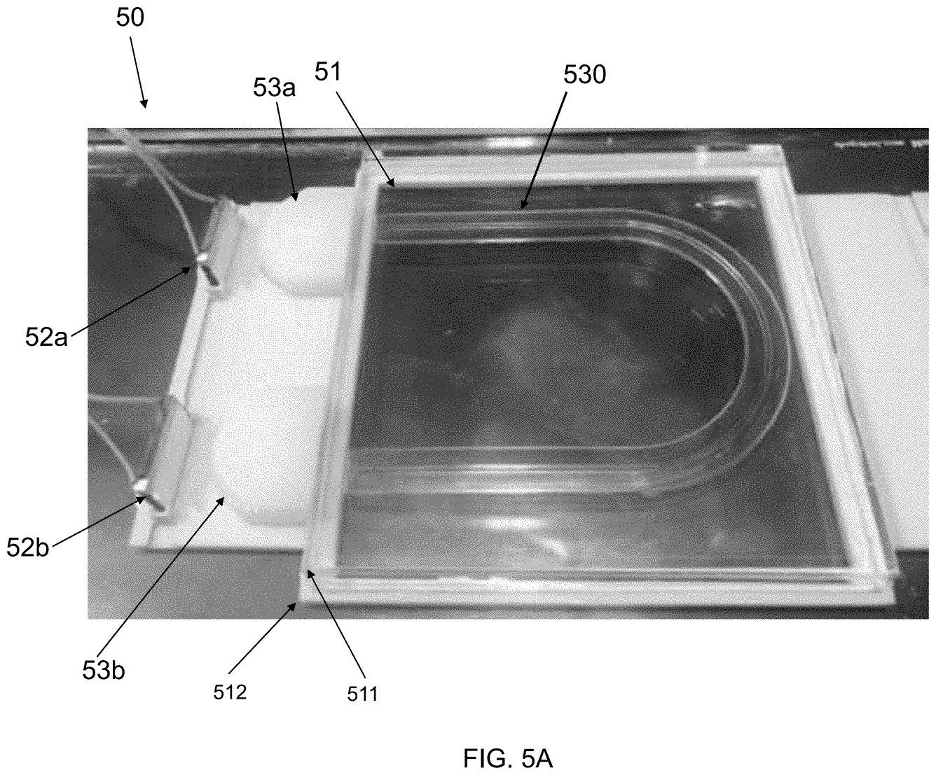

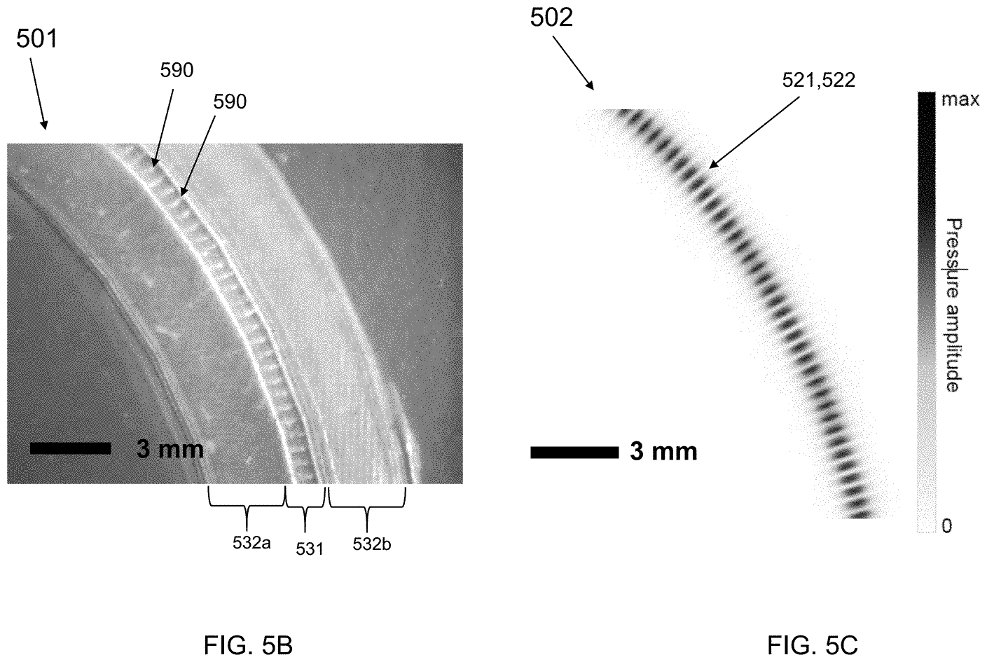

The acoustic tweezer devices 100, 200 can be used in an acoustic tweezer system that includes acoustic transducers (e.g., piezoelectric transducers) and acoustic lenses that direct acoustic energy from the transducers into opposite ends of a waveguide formed in a waveguide control structure. FIGS. 3A and 5A are photographs of two different acoustic tweezer devices arranged in respective systems that includes two transducers and two lenses. The device of FIG. 3A includes a linear waveguide and corresponding particle path and the device of FIG. 5A includes a curved waveguide and corresponding particle path. FIG. 3B is a generic schematic of a system, showing the acoustic energy directed into the waveguide control structure. FIG. 3C is photograph of the operation of the system of FIG. 3A, and FIG. 4A is a photograph of the operation of a similarly arranged linear device with a dual-channel arrangement. FIG. 5B is a photograph of the operation of the system of FIG. 5A. Finally, FIGS. 3D, 5B, and 5C show simulations of the acoustic pressure amplitude in the microfluidic acoustic conduits of the devices of their respective preceding operational photographs.

In FIG. 3A, a photograph of a system 30 of the present disclosure is shown. The system 30 includes a device 31 utilizing a clear solid top material 311 and supported on the bottom by a substrate 312. A waveguide control structure 330 is disposed above the bottom glass plate 312, with a fluid layer arranged between the waveguide control structure 330 and the top glass plate 311. The waveguide control structure 330 forms a linear waveguide that ends from a first (left) end of the device 31 to a second (right) end. Each end of the waveguide is bounded by an acoustic lens 33a, 33b disposed between the end and an acoustic transducer 32a, 32b (e.g., an acoustic wave generator, generally). The acoustic transducer 32a, 32b generator can be any suitable system for introducing a wave pattern to the lens to be focused and directed into the waveguide. Some example acoustic transducer 32a, 32b include piezoelectric ceramics such as piezoelectric, or interdigital transducers (IDT) that induce surface acoustic waves (SAW). In some embodiments, the system includes only one pair of wave sources.

Additionally, the acoustic lenses 33a, 33b, which are optional in some arrangements and/or for some types of acoustic transducers, are configured to focus and couple the incident waves from the acoustic transducer 32a, 32b into the device 31 such that acoustic energy propagates along the waveguide of the waveguide control structure 330. As shown in FIG. 3A, acoustic waves from the acoustic transducers 32a, 32b travel to and are focused through the acoustic lenses 33a, 33b, into the device 31. The waveguide structure layer 330 localizes the particles (not shown) within the device 31 along a linear path in the fluid layer that corresponds to the path of the waveguide below. The wave pattern in the waveguide can be configured in a variety of different ways to effect a prescribed particle motion, including both individual and relative parameters of the acoustic transducers 32a, 32b. Accordingly, through the combination of the device 31 and the wave pattern(s) introduced to the waveguide of the waveguide control layer 330, precise control can be achieved over particles disposed in the fluid layer.

FIG. 3B is a schematic illustration of the system 30 of FIG. 3A. The device 31 includes the solid top material 311, the bottom substrate 312, the fluid layer 320 and the waveguide control structure 330. The acoustic lenses 33a, 33b are disposed proximate to the ends of the device 31 having ends of the waveguide in the waveguide control structure 330. Waves 33a, 33b generated by the acoustic transducers 32a, 32b travel in the direction (represented by arrows 39a, 39b) of the acoustic lenses 33a, 33b. The acoustic lenses 33a, 33b further direct the waves 33a, 33b into the waveguide control structure 330.

FIG. 3C is a photograph of taken through a glass top layer 311 of the device 31 and shows a microfluidic chamber 301 with particles 390 disposed therein and formed above a waveguide 331 of the waveguide control structure 330. This specific waveguide structure is illustrated in FIG. 1E. In operation, the particles 390 in the fluid layer of the device are trapped by and can be moved by the acoustic energy directed into the waveguide 331 by the acoustic lenses 33a, 33b from the acoustic transducers 32a, 32b. The correspondence between acoustic field and particle positions can be clearly seen. These particles 390 are negative acoustic contrast particles that are attracted to and trapped by the antinodes or peaks 321 of the acoustic field. The lighter ovals in the image are concentrations of small particles that have been trapped by the acoustic fields. The darker gaps between the light ovals are regions of low acoustic amplitude from which the particles have been pushed out by the steep gradient of the acoustic field. FIG. 3D shows a computer simulation 302 of the pressure amplitude at the interface of the fluid layer 320 and waveguide control structure 330 of the acoustic tweezer system operation of FIG. 3C. The microfluidic acoustic channel above the waveguide 331 shows an increased pressure amplitude (represented by shaded regions 321) patterned between areas of low pressure-amplitude (represented by unshaded regions 322) during operation of the device.

FIG. 4A is a photograph of taken through a glass top layer of an example acoustic tweezer device and shows a microfluidic chamber 401 with particles 490 disposed therein and formed above two parallel waveguides 431a, 431b of a waveguide control structure below the fluid layer. The dual-waveguide structure of FIG. 4A is illustrated schematically in FIG. 2C. In operation, the particles 490 in the fluid layer of the device are trapped by and can be moved by the acoustic energy directed into the waveguides 431a, 431b by the acoustic lenses from the acoustic transducers. The correspondence between acoustic field and particle positions can be clearly seen. These particles are positive acoustic contrast particles that are attracted to and trapped by the nodes or valleys (422a, 422b of FIG. 4B) of the acoustic field. The vertical lines visible in the photograph of FIG. 4A are concentrations of small particles 490 that have been trapped by the acoustic fields. The particles 490 are trapped in the shape of thin lines because the acoustic nodes (422a, 422b of FIG. 4B) are thin. FIG. 4B depicts a simulation 402 of the pressure amplitude at the interface of the fluid layer and waveguide control structure of the acoustic tweezer system shown in operation in FIG. 4A. The simulation shows a series of pressure maxima (represented by shaded regions 421a, 421b) separated by areas of low pressure amplitude (represented by unshaded regions 422a, 422b) in two parallel microfluidic acoustic conduits. The acoustic waves create a system of patterned high and low pressure amplitude with which particles are trapped and mobilized.

FIG. 5A shows an acoustic tweezer system 50 of the present disclosure in which an acoustic tweezer device 51 includes a top glass plate 511, a bottom glass plate 512, and a waveguide control structure 530 and fluid layer (clear, not visible) disposed between the top and bottom plates 511, 512. The waveguide control structure 530 has a single-channel waveguide formed therein with a U-shaped path that extends from a first location on a first end of the device 51 and back to a second location on the first end. The system 50 includes two acoustic lenses 53a, 53b, one arranged at each end of the waveguide along with a corresponding one acoustic transducer 52a, 52b. In operation, the acoustic transducers 52a, 52b project acoustic energy to the lenses 53a, 53b and the lenses concentrate and direct the acoustic energy into the waveguide to create a microfluidic acoustic conduit in the fluid layer above the waveguide control structure 330.

In FIG. 5B, a photo shows a closer view of the path of the particles within the microfluidic channel 501, focused specifically on a small region of the waveguide control structure 530. Visible are the two lateral ends 532a, 532b of the waveguide control structure (e.g., 132a, 132b of FIGS. 1A-E), and the waveguide 531 (e.g., waveguide 131 of FIGS. 1A-F. FIG. 5B shows thin white lines that are clusters of small particles 590 trapped by the acoustic fields above the waveguide 531. These are negative acoustic contrast particles that are trapped in the acoustic wave peaks or antinodes 521. There is one cluster of particles for each peak of the acoustic field. FIG. 5B shows how particles can be trapped and transported along a curved path defined by a curved waveguide 530. FIG. 5C depicts a simulation 502 of the pressure amplitude at the interface of the fluid layer and the waveguide structure layer during the operation of the acoustic tweezer system shown in FIG. 5B. Operation of the system creates a pattern of high pressure-amplitude (depicted as shaded regions 521) and low pressure amplitude (depicted as unshaded regions 522) along the path 502 formed by the path-forming structure within the waveguide structure. The path of the acoustic wave patterns 521,522 has a substantially U-shape as it mirrors the shape of the waveguide 531 within the waveguide control structure 330.

In the photographs of FIGS. 3A and 5A, two piezoelectric transducers with a 1 MHz resonant frequency serve as acoustic sources. In the examples of FIGS. 3C and 5B, single-frequency waves are generated by both transducers with a function generator and amplified by power amplifiers. PDMS lenses, which can be tapered at both ends to enhance the coupling into a guided mode, focus and couple the incident waves into the waveguide. A standing wave pattern was created along the path of the waveguides, with colored PDMS particles with sizes smaller than 150 μm dispensed in the fluid layer. The particles rapidly concentrated to the pressure antinodes when the acoustic sources are turned on, whereafter there photographs of FIGS. 3C and 5B were taken. By adjusting the relative phase between two piezoelectric transducers, the standing wave inside the waveguide trap and move the particles along a predefined path in the open microfluidic chamber without a solid boundary.

In illustrative embodiments, a method of trapping and manipulating particles with acoustic tweezers comprises applying an electrical signal of the same frequency to transducers at one or more ends of the waveguide control structure. The transducers then launch an acoustic wave that is confined to the waveguide control structure. Particles disposed within the fluid channel will be attracted to pressure nodes or antinodes in the acoustic field, depending on the acoustic contrast of the particles. At this stage the particles are trapped and static. To move the trapped particles along the waveguide control structure, the frequency of the electrical signal applied to one end of the waveguide is slightly changed. This change creates a slowly moving acoustic field structure that carries the trapped particles along with it. Whether the frequency is increased or decreased controls the direction of particle transport above the waveguide, and the magnitude of the frequency chance controls the velocity of transport. By sensing or measuring aspects of the particle transport, an active feedback method of control can be implemented in which key parameters such as particle velocity are measured and used to actively adjust the electrical signal applied to the transducers in order to maintain or deliver certain transport parameters. One such method of sensing involves imaging the particles and flow and using automated computer image analysis to derive the sensed quantities. Another method involves placing a small sensor in the directly microfluidic chamber that can sense particles optically, and the signal from this sensor is used in the feedback control system.

### Example Structures and Design Principles

FIG. 6A is a representative example of the layers of an acoustic tweezer device, and FIG. 6B shows a waveguide formed in the waveguide control structure of FIG. 6A, with a secondary region formed on a side of the waveguide control structure opposite the fluid layer. FIG. 7 shows an alternate arrangement of a waveguide where a secondary region is formed on a side of the waveguide control structure facing the fluid layer and a thin impermeable membrane is placed between the fluid layer and the waveguide control structure to enclose the secondary region.

FIG. 6A shows a simplistic example layout of the layers of a device 600 of the present disclosure. The example microfluidic device 600 includes four layers: a top cover 611, a fluid layer 620, a bottom substrate 612 and a waveguide control structure 630. In operation, acoustic energy in the waveguide 631 forms a microfluidic acoustic conduit 639 in the fluid layer to trap and transport particles through the fluid layer 620 and along the path of the waveguide 631 below. In prior art systems, a solid structure may be needed inside a fluid layer to assist in the directing of particles, and that solid structure may be attached to a substrate layer. Examples of the present disclosure include the waveguide structure 630 disposed below the fluid layer 620 and having formed therein a waveguide 631. By arranging the waveguide control structure 630 external to the resultant microfluidic acoustic conduit 639 (e.g., not within fluid layer 630), wave propagation can be controlled by the waveguide structure 630, and thus, the particle motion from outside the fluid layer.

In FIG. 6B, a layout of a device of the present disclosure is shown with a secondary substrate region 640 formed in the waveguide control structure to create a single-channel waveguide 311. The device 600 comprises the top cover 611, the fluid layer 620, the bottom substrate 612 and the waveguide control structure 630. Within cavities and/or regions of the waveguide control structure 630 is a secondary region 640. The secondary region 640 bounds and defines a waveguide 631 within the waveguide control structure 630. The waveguide 631 is further bounded by two lateral bounding regions 632a and 632b of a thickness that is less than the thickness of the waveguide 631. The secondary region 640 has a high acoustic contrast with both the fluid layer 620 and the waveguide structure 630 to enable waveguiding of acoustic energy through the device to trap and move particles in the fluid layer 620 adjacent to the waveguide 631.

The top cover 611 can be any thin material that contains the fluid layer 620 from the top and can be optically transparent to enable visual observation of the microfluidic acoustic conduit 639. The top layer 611 may be made from, but is not limited to, glass, plastic, or metal. In some embodiments, the top cover 611 can be optionally removed. In these examples, the device can be configured such that propagation of the acoustic energy is not affected by the presence of the top layer 611. In some other examples, the top cover 611 can be used to help guide the acoustic waves present in the waveguide 631.

The fluid layer 620 can be fluid (e.g., water, oil, solution, etc.) or made with discrete fluid droplets. The bottom substrate 612 can be made of any arbitrary solid material and can be used to support the device 600 mechanically. In some examples, the substrate 612 is optionally not included. The waveguide control structure 630 can be composed of one or more materials. In certain embodiments, the waveguide control structure 630 is comprised of two different materials, one of which forms the secondary region 640. A first material can a solid that has mechanical properties either comparable to water, such as PDMS or rubber, or is significantly stiffer and more dense than water, such as aluminum or glass or silicon or silicon oxide, or the like. The second material of the waveguide control structure that forms the secondary region 640 can have high acoustic contrast with both the fluid layer 620 and the first material. The secondary region 640 can include a gas such as air, a vacuum, or an aerogel.

FIG. 7 shows an example layout of a device of the present disclosure. The example microfluidic device 700 includes four layers: a top cover 711, a fluid layer 720, a membrane 750 and a waveguide control structure 760. The waveguide control structure 760 is disposed below the fluid layer 720 and has formed therein two secondary regions 740a, 740b on a top face 769 of the waveguide control structure 760 that faces the fluid layer 720. The secondary regions 740a, 740b are formed as separate parallel-extending cavities in the top face 769 and between them is defined a waveguide portion 761 that, when acoustic energy is delivered therethrough, creates a microfluidic acoustic conduit 739 in a localized region of the fluid layer adjacent to and along the path of the waveguide 761. The membrane 750 is a thin, impermeable boundary that separates the fluid layer 720 from the waveguide structure 760 and the two secondary regions 740a, 740b therein, acting as an insulation layer to preserve the shape of the fluid layer 720. The membrane 750 can be made of any material that does not impede the interaction between acoustic waves in the fluid layer 720 and the secondary regions 740a and 740b. In some embodiments, the membrane 750 is a thin layer of rigid solid material, or a layer of a material, such as PDMS.

### Waveguide Control Structures: Materials and Fabrication

In some embodiments, a PDMS layer is used to construct the waveguide control structures disclose herein, which can be fabricated with the standard PDMS molding process. One example of waveguide control structure construction includes a negative mold fabricated with stereolithography 3D printing and treated with trichloro vapor in a vacuum chamber for a period of time. In this example, part A and part B of PDMS are mixed thoroughly by 10:1 weight ratio, degassed in a vacuum chamber, and then poured into the mold. The mold is degassed, and then baked in an oven at 120 degrees Celsius for an hour for the silicone to cure. The PDMS is then separated from the mold and attached to a glass plate to form the waveguide control structure. In some embodiments, other rubber-like materials are utilized for construction. These materials may be created through processes such as molding, etching, or 3D printing.

Another example waveguide control structure construction includes PDMS microparticles. In this example, microparticles of polydimethylsiloxane are formed by mixing PDMS base (e.g., premixed with ink) and curing agent thoroughly by a 10:1 weight ratio and adding to a water bath with 1 w % non-ionic surfactant PEG-PPG-PEG. The emulsion may be heated at 70 degrees Celsius and continuously agitated using a mixer for an hour. The cooled mixture then passes through a 100 mesh sieve to keep particles smaller than 150 μm.

In some examples, components of the system, such as the waveguide control structure and/or the secondary region(s) are made utilizing hydrogel. Structures are created using hydrogel or other water-like materials through processes known in the art, including but not limited to molding, etching, or 3D printing. In some embodiments, manufacturing of the acoustic tweezer devices include structures added onto a substrate layer (e.g., substrate layer 612), which can be performed through processes such as lithography, or chemical or physical deposition. Examples of the secondary regions disclosed herein include vacuum cavities, or cavities filled with any gas such as air, nitrogen, oxygen, or regions of a gas-filled porous material, such as aerogels.

Certain embodiments include components created using a subtracting method, where a structure is formed by removing material. The material may include, but is not limited to, steel, aluminum, glass, or silicon. In some embodiments, the waveguide control material is patterned on the boundary to create the waveguide and space for the secondary regions, either facing the fluid layer or on the opposite surface, which can be done as an additive or subtractive process. Thus, the surface may consist of patterning of one or more materials such as aerogel, gas-containing materials, or nanomaterials. Surface treatment on a substrate may change its acoustical properties through chemical or physical treatments.

Example Structures

In some examples, one or more structures of an acoustic tweezer device can be deformable, tunable, bendable, foldable, flexible, or otherwise dynamically alterable. A deformable structure may be achieved by forming structures with materials that, for example, respond to current or voltage. Some examples of materials include, but are not limited to, piezoelectric ceramics (e.g., lithium nitrate, lead zirconate titanate), piezoelectric polymers (e.g., polyvinylidene fluoride), and dielectric elastomers. In some examples, the materials used are responsive to heat and temperature. In certain examples, the structures of the present disclosure utilize materials that respond to electromagnetic field input or light. These materials may include aluminum nitride (AlN) or other light-sensitive materials. The materials are deformable or malleable in response to stress. These materials are typically soft and flexible such that they may, for example, stretch, compress, shear, bend, or deform in one or more ways.

The waveguide can include a smoothly changing profile, including profiles designed using supersymmetry that can create a Y-split in the waveguide control structure with no acoustic reflection. Example systems include resonators formed with the one or more waveguides of the present disclosure. The resonator may be a ring resonator such that the resonator is a closed loop coupled to a sound input and output. In some embodiments, the waveguide can have sharp changes in the profile at one or more points along the overall waveguide. These sharp changes generate controlled acoustic reflections and are thus able to create different acoustic standing waves in different portions of the overall waveguide. In some embodiments, the waveguide will include finite length side channels that detour away from the main waveguide. These side channels also generate controlled acoustic reflections and can thus generate different acoustic standing waves in different portions of the overall waveguide.

In some embodiments, the system includes point or structure arrays of an acoustic metamaterial. The material may include phononic crystals. The phononic crystals may be single crystals or may appear in multiple sections of phononic crystals. In certain embodiments, the point or structure arrays create topological structures within the system. In some embodiments, the array includes a gradient. In some embodiments, the array is a point array formed with resonating structures.

In certain embodiments, the system includes refractive index arrangements. These arrangements may include lenses including, for example, acoustic lenses to focus sound. The index arrangement may optionally include gradient index materials. In some embodiments, the system also utilizes material layers or gradients designed using transformation acoustics.

In some examples, the waveguide control structure can be configured with single, double, or multiple coupled waveguides. In some examples presented herein, polyamide particles used in the system have a diameter of 60 μm as shown in FIG. 4A. In certain examples, the device is configured to trap particles not only along the center of the waveguide, but also aligned themselves inside each potential well of the acoustic field. This result can be achieved by controlling a standing wave ratio and the depth of local minima in the fundamental mode, so that particles experience an anisotropic radiation force, where the pressure gradient in the transverse direction is smaller than in the propagation direction. The ratio between these two forces can be further tuned by adjusting the input standing wave ratio.

### Thouless Pump

FIG. 8A-8C illustrate a novel way of operating an acoustic tweezer device, such as the acoustic tweezer devices disclosed herein, to create a Thouless pump. FIG. 8A shows a time sequence of a simulation of the manipulation of a captured particle through space and time within a Thouless pump arrangement of an acoustic tweezer system according to aspects of the present disclosure, and FIG. 8B shows photographs of a real device operating according to the simulation. Finally, FIG. 8C is a graph of particle pumping speed versus frequency detuning of the input fields of the simulated and real Thouless pump arrangements of FIGS. 8A and 8B.

The acoustic tweezer devices herein can be operating to form a Thouless pump with the acoustic energy directed through the waveguide(s). In FIG. 8A, a diagram 801 shows a particle 891 that is trapped by a sound wave (represented by line 802) over time. As time passes, the particle 891 is manipulated linearly by the sound wave in the direction the sound wave travels. This movement depicted in the diagram 801 is similar to the process utilized by a Thouless pump in the field of quantum mechanics, in which a Thouless pump enables the robust transport of charge through an adiabatic cyclic evolution of the underlying Hamiltonian. In illustrative examples, such a concept can also be realized in acoustic tweezers to achieve robust, continuous transport of particles at a controlled speed. In FIG. 8A, a 1D system is simulated with no dispersion. When two counter-propagating waves have slightly different frequencies, ω_{1,2}=ω₀±δω (δω<<ω₀), the resulting total field becomes Equation 1:

$$p = {p}_{0} {e}^{j [ ( {ω}_{0} + δω ) t - \frac{{ω}_{0} + δω}{c} x ]} + {p}_{0} {e}^{j [ ( {ω}_{0} - δω ) t - \frac{{ω}_{0} + δω}{c} x ]} = 2 {p}_{0} {e}^{j ( {ω}_{0} t - \frac{δω}{c} x )} cos ( δω t - \frac{{ω}_{0}}{c} x ) . \qquad Equation ( 1 )$$

Here the two waves have the same amplitude. Similar results can be found when the two waves have different amplitudes, which is shown in more detail below.

The resulting field shows a fast oscillating wave modulated by a slowly moving envelope. Such an envelope travels at a speed of cδω/ω₀, much slower than the speed of sound in the medium as shown in FIG. 8A. The resulting Gor'kov potential may behave like a Thouless pump that transports particles along the waveguide path with a controlled and adjustable speed.

FIG. 8B shows the corresponding experimental image sequence in time, of the simulation in FIG. 8A. The image sequence 810 shows a particle 891 trapped in a sound wave in a microfluidic acoustic conduit above a waveguide (depicted by lightly shaded area 831) of an acoustic device according to aspects of the present disclosure (e.g., the system 30 and device 31 of FIG. 3A). The speed of the propagating potential can be controlled by tuning the amount of frequency detuning. In FIG. 8C, a graph 820 shows the particle 891 velocity under frequency detuning through both theoretical prediction shown in FIG. 8A and experimental measurements shown in FIG. 8B. At center frequency f₀=1 MHz, the phase speed in the waveguide system calculated from the simulation of FIG. 8a is ω/k=1304 mm/s. Experimental results, depicted as dots on the graph 820, showed excellent agreement with the theoretical calculation, featuring a linear relationship between the pumping speed and amount of detuning. The small discrepancy can be attributed to the fabrication error and imperfect clock in the function generator.

Thouless pump can also be achieved in acoustic tweezers to achieve robust transport of particles at controlled speed. In certain embodiments, two counter propagating waves with the same amplitude are utilized. In a 1D Thouless pump using waves with detuned frequencies at different amplitudes, the two counter propagating waves have slightly different frequencies, ω_{1,2}=ω₀±δω (δω<<ω₀) and pressure amplitudes p₁, p₂. The resulting total field will become:

$$p = {p}_{1} {e}^{j [ ( {ω}_{0} + δω ) t - \frac{{ω}_{0} + δω}{c} x ]} + {p}_{1} {e}^{j [ ( {ω}_{0} - δω ) t - \frac{{ω}_{0} + δω}{c} x ]} = {e}^{j ( {ω}_{0} t - \frac{δω}{c} x )} [ {p}_{1} {e}^{j ( δω t - \frac{{ω}_{0}}{c} x )} + {p}_{2} {e}^{- j ( δω t - \frac{{ω}_{0}}{c} x )} ] . \qquad Equation 2 ]$$

The amplitude square, proportional to the potential at each point can be written as:

$${\vert p \vert}^{2} = {\vert {p}_{1} {e}^{j ( δω t - \frac{{ω}_{0}}{c} x )} + {p}_{2} {e}^{- j ( δω t - \frac{{ω}_{0}}{c} x )} \vert}^{2} = {p}_{1}^{2} + {p}_{2}^{2} + 2 {p}_{1} {p}_{2} cos2 ( δω t - \frac{{ω}_{0}}{c} x ) . \qquad Equation ( 3 )$$

Equation (3) shows that this potential is moving at a constant, slow speed. By tuning the amplitude ratio between the two waves, the strength of the potential well can also be controlled, so that a controllable, anisotropic potential well can be applied to the trapped particle.

The radiation force on the particle can be calculated semi-analytically. First, the acoustic field is obtained through simulations. Then for a specific particle, the Gor'kov potential field U can be calculated as:

$$U = 2 {π R}^{3} ( \frac{〈 {p}^{2} 〉}{3 {ρ}_{0} {c}_{0}^{2}} {f}_{1} - \frac{{ρ}_{0} 〈 {v}^{2} 〉}{2} {f}_{2} ) \qquad Equation ( 4 )$$

Where

$${f}_{1} = 1 - \frac{{ρ}_{0} {c}_{0}^{2}}{{ρ}_{p} {c}_{p}^{2}} ,$$

$${f}_{2} = \frac{2 ( {ρ}_{p} - {ρ}_{p} )}{2 {ρ}_{p} + {ρ}_{0}}$$

are constants that characterize monopole and dipole responses, respectively. The subscript p denotes the particle. The radiation force can then be estimated using F=−∇U. Here the Gorkov potential can provide a close approximation since the particle sizes are much smaller than the operating wavelength.

### Acoustic Lenses

FIGS. 9A and 9B are simulation example acoustic lenses according to aspects of the present disclosure configured for use with a single and dual channel acoustic tweezers, respectively. Example acoustic lenses disclosed herein can be used to focus and direct acoustic energy from a wave generator into the physically smaller waveguide device (e.g., a waveguide of a waveguide structure layer). The lens can include a material whose sound speed differs from that in water, for example, PDMS, which is advantageous for devices that utilize a fluid layer made of water or an acoustically-similar fluid. Because sound propagates at different speeds PDMS than in fluids such as water, controlling the thickness profile of the acoustic lens can bend the direction of incoming sound and focus the sound energy at a desired location. Example acoustic lenses can be made with any material as long as the sound speed in that material is different from that in the fluid utilized in the fluid layer of the device. Example acoustic lenses focus acoustic waves generated by a wave generator into a concentrated area of the device, such as an end of a waveguide.

FIG. 9A shows a simulation of acoustic fields traveling through an acoustic lens 900. An incoming plane wave 904 propagates from the input side (e.g., the bottom) 903 of the acoustic lens 900 and is focused into an oval shape 902 at the output side (e.g., the top) 901 of the lens 900. The oval shape 902 matches the shape of acoustic field inside the device. In the simulation of FIG. 9A, the acoustic lens 900 is about 24 mm wide and about 15 mm in depth. The thickness can be characterized by T=23−0.06(x²+y²) mm. In FIG. 9B, a similar diagram depicts a simulation of acoustic fields from a coupled waveguide system traveling through an acoustic lens 910. The plane wave 914 enters the input side 913 of the acoustic lens 910 and is focused into two substantially ovular shapes 902a, 902b at the output side 911 of the lens 910 to then enter the device. The two substantially ovular shapes 902a, 902b create an elliptical pressure distribution at the output side 911. In FIG. 9B, the thickness profile is T=23−0.06x²−0.04y² mm.

Example acoustic lenses can be made from a specifically shaped material with a sound speed different from a surrounding fluid. The acoustic lens can include be a structure with a smooth profile gradient and the lens can be made from rigid boundaries, like a horn, or could be composed of thin layers of different materials. In other embodiments, the acoustic lens is a grating structure to match the acoustic fields between the waves inside and outside the microfluidic chamber.

Other example acoustic lenses are designed to couple a plane wave emitted by a piezoelectric transducer into a microfluidic chamber. Example acoustic lenses can concentrate the input acoustic power as well as mimic the mode shape in the waveguide structure layer to maximize the coupling efficiency. In some examples, PDMS molding can be used to fabricate the acoustic lenses. Since the sound speed in PDMS is slower than in water, thicker PDMS can result in a larger phase delay.

The systems and methods described herein can be implemented in hardware, software, firmware, or combinations of hardware, software and/or firmware. In some examples, the systems and methods described in this specification may be implemented using a non-transitory computer readable medium storing computer executable instructions that when executed by one or more processors of a computer cause the computer to perform operations. Computer readable media suitable for implementing the systems and methods described in this specification include non-transitory computer-readable media, such as disk memory devices, chip memory devices, programmable logic devices, random access memory (RAM), read only memory (ROM), optical read/write memory, cache memory, magnetic read/write memory, flash memory, and application-specific integrated circuits. In addition, a computer readable medium that implements a system or method described in this specification may be located on a single device or computing platform or may be distributed across multiple devices or computing platforms.

One skilled in the art will readily appreciate that the present disclosure is well adapted to carry out the objects and obtain the ends and advantages mentioned, as well as those inherent therein. The present disclosure described herein are presently representative of preferred embodiments, are exemplary, and are not intended as limitations on the scope of the present disclosure. Changes therein and other uses will occur to those skilled in the art which are encompassed within the spirit of the present disclosure as defined by the scope of the claims.

No admission is made that any reference, including any non-patent or patent document cited in this specification, constitutes prior art. In particular, it will be understood that, unless otherwise stated, reference to any document herein does not constitute an admission that any of these documents forms part of the common general knowledge in the art in the United States or in any other country. Any discussion of the references states what their authors assert, and the applicant reserves the right to challenge the accuracy and pertinence of any of the documents cited herein. All references cited herein are fully incorporated by reference, unless explicitly indicated otherwise. The present disclosure shall control in the event there are any disparities between any definitions and/or description found in the cited references.

The embodiments of the present disclosure described above are intended to be merely exemplary; numerous variations and modifications will be apparent to those skilled in the art. One skilled in the art will appreciate further features and advantages of the disclosure based on the above-described embodiments. Such variations and modifications are intended to be within the scope of the present disclosure as defined by any of the appended claims. Accordingly, the disclosure is not to be limited by what has been particularly shown and described, except as indicated by the appended claims. All publications and references cited herein are expressly incorporated herein by reference in their entirety.

1. An acoustic tweezer device, comprising:
a fluid layer; and
a waveguide control structure disposed adjacent to the fluid layer and comprising solid material defining at least one cavity having a different acoustic impedance than both the solid material and the fluid layer,
wherein the at least one cavity defines a waveguide in the solid material, the waveguide extending along the fluid layer and defining a path of an acoustic microfluidic conduit in an adjacent portion of the fluid layer,
wherein the waveguide control structure is configured to direct acoustic energy along the waveguide and through the acoustic microfluidic conduit to trap and manipulate particles in the acoustic microfluidic conduit without any physical boundary in the fluid layer.

2. The device of claim 1, wherein the at least one cavity comprises separate first and second lateral portions extending along the fluid layer and defining the waveguide in the solid material therebetween.

3. The device of claim 2, wherein the path of the waveguide defines a narrow and arbitrarily shaped path of the acoustic microfluidic conduit within the fluid layer.

4. The device of claim 2, wherein the waveguide comprises a portion of the solid material having a greater thickness than adjacent portions of the solid material disposed between the first and second lateral portions of the cavity and the fluid layer.

5. The device of claim 1, wherein the waveguide control structure is configured to trap at least one of particles having positive acoustic contrasts or particles having negative acoustic contrasts in the acoustic microfluidic chamber.

6. The device of claim 1, wherein the waveguide comprises first and second waveguides extending together along the fluid layer, and wherein a portion of the at least one cavity is disposed between the first and second waveguides.

7. The device of claim 6, wherein the first and second waveguides define separate first a second acoustic microfluidic conduits.

8. The device of claim 6, wherein the first and second waveguides together define a single acoustic microfluidic conduits in a portion of the fluid layer adjacent to a region of the waveguide control structure between the first and second waveguides.

9. The device of claim 1, further comprising a substrate layer disposed adjacent to the waveguide control layer and opposite to the fluid layer.

10. The device of claim 1, further comprising a cover layer disposed adjacent to the fluid layer and opposite to the waveguide control layer.

11. The device of claim 1, wherein the at least one cavity is filled with a gas or contains a vacuum.

12. The device of claim 1, wherein the fluid layer comprises water and the solid material of the waveguide structure comprises polydimethylsiloxane.

13. The device of claim 1, wherein the waveguide control structure comprises a membrane layer disposed between the fluid layer and the at least one cavity.

14. The device of claim 13, wherein the membrane layer at least partially encloses the at least one cavity.

15. The device of claim 1, wherein the acoustic microfluidic conduit defines a quasi-2D open chamber.

16. The device of claim 1, wherein the waveguide control structure comprises at least one of a waveguide, a point array, a shaped hydrogel, a surface pattern, and/or a surface layer material.

17. The device of claim 1, further comprising:
a first acoustic lens acoustically coupled to a first end of the waveguide; and
a second acoustic lens acoustically coupled to a second end of the waveguide,
wherein the first and second ends of the waveguide comprises respective first and second ends of the path of the microfluidic acoustic conduit, and
wherein the first and second acoustic lenses are each configured to direct and concentrate acoustic energy from a respective acoustic source into a respective one of the first or second ends of the waveguide.

18. The device of claim 17, wherein the first acoustic lens is disposed adjacent to the first end of the waveguide, and wherein the second acoustic lens is disposed adjacent to the second end of the waveguide.

19. The device of claim 1, wherein the at least one cavity has positive acoustic contrast with both the solid material and the fluid layer.

20. An acoustic tweezer device, comprising:
a fluid layer; and
a waveguide control structure disposed adjacent to the fluid layer and comprising solid material, the solid material at least partially surrounding at least one region having a different acoustic impedance than both the solid material and the fluid layer,
wherein the at least one region defines a waveguide in the solid material, the waveguide extending along the fluid layer and defining a path in an adjacent portion of the fluid layer,
wherein the waveguide control structure is configured to direct acoustic energy along the waveguide and also through the fluid layer, in the direction of the waveguide, in a localized region of the fluid layer adjacent to the waveguide, and
wherein the acoustic energy in the fluid layer adjacent to the waveguide traps and manipulates particles in the localized region along the path of the waveguide control structure.

21. A method of trapping particles with an acoustic tweezer device, the method comprising
directing acoustic waves into a first end of a waveguide of an acoustic tweezer device, the waveguide defined by at least one cavity in a waveguide control structure that is adjacent to a fluid layer of the device, the at least one having a different acoustic impedance than both the waveguide control structure and the fluid layer;
directing acoustic waves into a second end of the waveguide; and
adjusting at least one of the acoustic waves into the first or second ends of the waveguide to trap and manipulate particles in an acoustic microfluidic conduit in the fluid layer adjacent to the waveguide,
wherein waveguide extends along a path along an interface between the fluid layer and the waveguide control structure and the acoustic waves directed into the first and second ends of the waveguide is propagated along the path to define the acoustic microfluidic conduit in a portion of the fluid layer adjacent to the path.

22. The method of claim 21, wherein the adjusting at least one of the directing acoustic waves into the first or second ends of the waveguide to trap and manipulate particles in the acoustic microfluidic conduit is conducted without any physical boundary in the fluid layer.

23. The method of claim 21, wherein the waveguide control structure is configured to trap at least one of particles having positive acoustic contrasts or particles having negative acoustic contrasts in the acoustic microfluidic chamber.

24. The method of claim 21, wherein adjusting at least one of the directing acoustic waves into the first or second ends of the waveguide comprise forming a moving Thouless pump arrangement in the acoustic microfluidic conduit.

25. The method of claim 21, wherein the waveguide control structure defines two or more waveguides that define a single acoustic microfluidic conduit.

26. The method of claim 21, wherein directing acoustic waves into at least one of the first or second ends of the waveguide comprises concentrating acoustic energy from an acoustic source using an acoustic lens arranged between the acoustic source and a respective one of the at least one of the first or second ends.

27. The method of claim 21, where adjusting at least one of the directing acoustic waves into the first or second ends of the waveguide comprises forming a static or dynamic standing wave pattern along the microfluidic acoustic conduit.

28. The method of claim 21, wherein the particles in the fluid layer are chosen from a group consisting of: biological tissues, cells, or cell products.

29. The method of claim 21, wherein the at least one cavity is filled with a gas or contains a vacuum.

30. The method of claim 21, wherein the fluid layer comprises water and the solid material of the waveguide structure comprises polydimethylsiloxane.

31. The method of claim 21, wherein the acoustic microfluidic conduit defines a quasi-2D open chamber.
